(19) United States
(12) Patent Application Publication
(10) Pub. No.: US 2019/0087896 A1
(43) Pub. Date: Mar. 21, 2019

(54) METHOD OF COPY TRADING AND SYSTEM THEREOF

(71) Applicant: eToro Group Ltd., TORTOLA (VG)

(72) Inventors: Johnathan Alexander ASSIA, SAVYON (IL); Mordechay GOLDKLANG, GIVAT SHMUEL (IL); Dan SHUMER, KFAR YONA (IL); Paz DIAMANT, GIVAT SHMUEL (IL)

(73) Assignee: eToro Group Ltd., Tortola (VG)

(21) Appl. No.: 16/079,530

(22) PCT Filed: Feb. 15, 2017
(86) PCT No.: PCT/IL2017/050200

§ 371 Date: Aug. 23, 2018

Related U.S. Application Data
(60) Provisional application No. 62/301,702, filed on Mar. 1, 2016.

(51) Int. Cl. G06Q 40/04; G06F 9/50; G06Q 50/00

(52) U.S. Cl. CPC G06Q 40/04; G06Q 50/01; G06F 9/5055

(57) ABSTRACT

A method and system for facilitating mirror trading of financial instruments in a trading network comprising a plurality of traders, the method comprising, by a processor operatively coupled to a memory, obtaining from the memory, criteria received from a copying trader for identifying at least one target trading position opened by at least one copied trader in respect of at least one instrument to mirror for the copying trader in a mirror portfolio associated with the copying trader, identifying at least one target trading position satisfying the obtained criteria, automatically opening, in the mirror portfolio, a basket of trading positions comprising one or more mirror positions, each mirror position corresponding to an identified target trading position, obtaining, from the memory, one or more liquidation triggers received from the copying trader to apply to the mirror portfolio, and automatically changing at least one liquidation trigger upon a performance measure for the mirror portfolio satisfying one or more trigger change criteria.

### TECHNICAL FIELD

The presently disclosed subject matter relates to mirror trading and, more particularly, a mirror trading of financial instruments.

### BACKGROUND

Social trading networks, a subcategory of online social networks, enables investors in financial markets to engage in social trading, a process through which online financial investors rely on user generated financial content as an information source for making financial trading decisions. One such method of social trading is mirror trading. Mirror trading enables traders to automatically, including e.g. according to specified rules, copy trading positions opened and managed by a selected investor in the social trading network.

However, there remains a need for additional trading tools to be implemented on a mirror trading system that enable mirror traders to automatically limit their exposure to basket losses and/or automatically lock in basket gains.

There also remains a need to reduce the computational complexity required for a computer system configured to, e.g., automatically limit a trader's exposure to basket losses and/or automatically lock in basket gains.

### GENERAL DESCRIPTION

In accordance with certain aspects of the presently disclosed subject matter, there is provided a method of facilitating mirror trading of financial instruments in a trading network comprising a plurality of traders, the method comprising, by a processor operatively coupled to a memory obtaining tram the memory, criteria received from a copying trader for identifying at least one target trading position opened by at least one copied trader in respect of at least one instrument to mirror for the copying trader in a mirror portfolio associated with the copying trader, identifying at least one target trading position satisfying the obtained criteria: automatically opening, in the mirror portfolio, a basket of trading positions comprising one or more mirror positions, each mirror position corresponding to an identified target trading position; obtaining, from the memory, one or more liquidation triggers received from the copying trader to apply to the mirror portfolio; automatically changing at least one liquidation trigger upon a performance measure for the mirror portfolio satisfying one or more trigger change criteria; and automatically liquidating the mirror portfolio upon the changed liquidation trigger being met by automatically liquidating all the trading positions in the basket of trading positions.

In accordance with certain other aspects of the presently disclosed subject matter, there is provided a system for facilitating mirror trading of financial instruments in a trading network comprising a plurality of traders, the system comprising a processor operatively coupled to a memory and configured to: obtain from the memory criteria received from a copying trader for identifying at least one target trading position opened by at least one copied trader in respect of at least one instrument to mirror for the copying trader in a mirror portfolio associated with the copying trader; identify at least one target trading position satisfying the obtained criteria; automatically open, in the mirror portfolio, a basket of trading positions comprising one or more mirror positions, each mirror position corresponding to an identified target trading position; obtain from the memory one or more liquidation triggers received from the copying trader to apply to the mirror portfolio; automatically change at least one liquidation trigger upon a performance measure for the mirror portfolio satisfying one or more trigger change criteria; and automatically liquidate the mirror portfolio upon the changed liquidation trigger being met by automatically liquidating all the trading positions in the basket of trading positions.

In accordance with certain other aspects of the presently disclosed subject matter, there is provided a non-transitory storage medium comprising instructions embodied therein, that when executed by a processor comprised in a computer, cause the processor to perform a method of facilitating mirror trading of financial instruments in a trading network comprising a plurality of traders, the method comprising: obtaining criteria received from a copying trader for identifying at least one target trading position opened by at least one copied trader in respect of at least one instrument to mirror for the copying trader in a mirror portfolio associated with the copying trader; identifying at least one target trading position satisfying the obtained criteria; automatically opening, in the mirror portfolio, a basket of trading positions comprising one or more mirror positions, each mirror position corresponding to an identified target trading position; obtaining one or more liquidation triggers received from the copying trader to apply to the mirror portfolio; automatically changing at least one liquidation trigger upon a performance measure for the mirror portfolio satisfying one or more trigger change criteria; and automatically liquidating the mirror portfolio upon the changed liquidation trigger being met by automatically liquidating all the trading positions in the basket of trading positions.

In accordance with further aspects and optionally in combination with other aspects, the obtained criteria includes criteria for identifying at least two target trading positions opened by at least two different copied traders.

In accordance with further aspects and optionally in combination with other aspects, the obtained criteria includes criteria for identifying at least one non-mirror trading position.

In accordance with further aspects and optionally in combination with other aspects, the obtained criteria includes at least an indication of each copied trader, said indication sufficient to discern each copied trader from other traders in the trading network.

In accordance with further aspects and optionally in combination with other aspects, the obtained criteria further includes an indication of one or more of: a specific target trading position, a specific instrument a specific instrument type, a specific position types, and a specific timeframes.

In accordance with further aspects and optionally in combination with other aspects, the obtained criteria further includes an indication that the at least one target trading position is one of: a previously opened target trading position and a not yet opened target trading position.

In accordance with further aspects and optionally in combination with other aspects, the method further comprises, upon the at least one changed liquidation trigger not being met automatically closing at least one mirror trading position in response to the corresponding trading position being closed.

In accordance with further aspects and optionally in combination with other aspects, automatically changing the at least one liquidation trigger comprises at least one of: raising the liquidation trigger and lowering the liquidation trigger.

In accordance with further aspects and optionally in combination with other aspects, automatically changing the at least one liquidation trigger comprises automatically changing the trigger according to one or more predetermined rules.

In accordance with further aspects and optionally in combination with other aspects, automatically changing the at least one liquidation trigger comprises changing the trigger in predetermined increments.

In accordance with further aspects and optionally in combination with other aspects, automatically changing the at least one liquidation trigger comprises repeatingly changing the liquidation trigger.

In accordance with further aspects and optionally in combination with other aspects, the performance measure satisfies the one or more trigger change criteria upon the performance measure being indicative of one or more of: a value of the portfolio breaching a predetermined threshold value, a change in a value of the portfolio breaching a predetermined threshold change.

In accordance with further aspects and optionally in combination with other aspects, the change is one of or more of: an absolute change and a relative change relative to a prior value.

In accordance with further aspects and optionally in combination with other aspects, one or more of the liquidation triggers is met upon at least one of a portfolio value and a change in a portfolio value breaching a predetermined threshold value.

In accordance with further aspects and optionally in combination with other aspects, one or more of the liquidation triggers is met upon a value of one or more trading positions in the basket of trading changing by a predetermined amount.

In accordance with further aspects and optionally in combination with other aspects, one or more of the liquidation triggers includes a stop loss.

In accordance with further aspects and optionally in combination with other aspects, one or more of the liquidation triggers includes a take profit.

In accordance with further aspects and optionally in combination with other aspects, one or more of the liquidation triggers includes a trailing stop loss.

In accordance with further aspects and optionally in combination with other aspects, one or more of the liquidation triggers includes a trailing take profit.

In accordance with further aspects and optionally in combination with other aspects, liquidating the mirror portfolio further comprises determining if a current value of the mirror portfolio breaches the changed at least one liquidation trigger.

In accordance with further aspects and optionally in combination with other aspects, determining if a current value of the mirror portfolio breaches the changed at least one liquidation trigger comprises: setting a target price threshold for one or more instruments held in one or more trading positions in the basket of trading positions; determining, using a computationally inexpensive operation, if any target price threshold is breached; and upon determining that at least one target price threshold is breached, calculating a current value of the portfolio using one or more computationally expensive operations, and determining if one of: the current value or a change in the current value, breaches the changed at least one liquidation trigger.

In accordance with further aspects and optionally in combination with other aspects, the one or more target price thresholds are set such that if all target price thresholds are breached, the changed at least one liquidation trigger will be breached.

In accordance with further aspects and optionally in combination with other aspects, the one or more target price thresholds are set for the one or more instruments in accordance with the current prices of each instrument and further in accordance with at least one of: each instruments' respective position size in the portfolio, and each instruments' respective volatility.

In accordance with further aspects and optionally in combination with other aspects, farther comprising, upon determining that the current value of the portfolio does not breach the changed at least one liquidation trigger, revising one or more of the target price thresholds in accordance with the current prices of the respective one or more target price thresholds such that no target price thresholds are breached.

In accordance with further aspects and optionally in combination with other aspects, the computationally inexpensive operation comprises, for each instrument, obtaining the current price of the instrument, comparing the current price to its respective target price threshold, and determining if the current price breaches the target price threshold.

In accordance with further aspects and optionally in combination with other aspects, the one or more computationally expensive operations comprises, for each trading position P in respect of an instrument, calculating a P&L of P using the formula

P&L_{P}=(p_{c}−p₀)×u

where P_{c} is the current price of the instrument per unit, p₀ is the initial price per unit, and u is the number of units traded in P.

In accordance with farther aspects and optionally in combination with other aspects, the current value V of the portfolio is calculated using the formula

$$V = C + {\sum }_{i = 1}^{n} {c}_{i} + {\sum }_{i = 1}^{n} P \& {L}_{i}$$

where C is the cash in the portfolio, cᵢ is the amount the trader has invested in the i-th trading position, and P&L is the P&L of the i-th trading position.

In accordance with further aspects and optionally in combination with other aspects, one or more target price thresholds are revised upon a trading position being closed.

In accordance with further aspects and optionally in combination with other aspects, one or more target price thresholds are revised upon a new trading position being opened.

In accordance with further aspects and optionally in combination with other aspects, one or more target price thresholds are revised upon a liquidation trigger being changed.

In accordance with further aspects and optionally in combination with other aspects, one or more target price thresholds are revised upon cash being transferred in or out of the portfolio.

In accordance with further aspects and optionally in combination with other aspects, further comprising, upon a copied trader transferring an amount of cash in or out of the copied trader's account, calculating a corresponding amount of cash to transfer in or out of the mirror portfolio, transferring the calculated amount of cash, and revising one or more of the target price thresholds for one or more instruments held in one or more trading positions in the basket of trading positions.

In accordance with certain other aspects of the presently disclosed subject matter there is provided a method of reducing computational complexity required for a processor operatively coupled to a memory to perform a task related to repetitively processing a plurality of objects in each repetition out of a plurality of repetitions and determining, if a condition is met in respect of the plurality of objects in any given repetition, to take an action, wherein processing the plurality of objects in a given repetition requires the processor to first process each object in the plurality of objects, in the given repetition, using a computationally expensive operation, the method comprising, by the processor: in each repetition, obtaining each object from the memory and, prior to said first processing, preprocessing each object in the plurality of objects using a computationally inexpensive operation and determining if the results of at least one preprocessing in respect of at least one object satisfies a predetermined criteria; and only upon determining that the results of at least one preprocessing of at least one object satisfies a predetermined criteria, thereafter processing each object using the computationally expensive operation and subsequently processing the plurality of objects to determine if the condition is met, and upon determining that the condition is met taking the action; thereby reducing the number of computationally expensive operations required to be performed in one or more repetitions.

In accordance with certain other aspects of the presently disclosed subject matter, there is provided a system for reducing computational complexity required for a processor to perform a task related to repetitively processing a plurality of objects in each repetition out of a plurality of repetitions and determining, if a condition is met in respect of the plurality of objects in any given repetition, to take an action, wherein processing the plurality of objects in a given repetition requires the processor to first process each object in the plurality of objects, in the given repetition, using a computationally expensive operation, the system comprising a processor operatively coupled to a memory and configured to: in each repetition, prior to said first processing, obtain each object from the memory and preprocess each object in the plurality of objects using a computationally inexpensive operation and determine if the results of at least one preprocessing in respect of at least one object satisfies a predetermined criteria; and only upon determining that the results of at least one preprocessing of at least one object satisfies a predetermined criteria, thereafter process each object using the computationally expensive operation and subsequently process the plurality of objects to determine if the condition is met, and upon determining that the condition is met taking the action; thereby reducing the number of computationally expensive operations required to be performed in one or more repetitions.

In accordance with certain other aspects of the presently disclosed subject matter, there is provided a non-transitory storage medium comprising instructions embodied therein, that when executed by a processor comprised in a computer, cause the processor to perform a method of reducing computational complexity required for the processor to perform a task related to repetitively processing a plurality of objects in each repetition out of a plurality of repetitions and determining, if a condition is met in respect of the plurality of objects in any given repetition, to take an action, wherein processing the plurality of objects in a given repetition requires the processor to first process each object in the plurality of objects, in the given repetition, using a computationally expensive operation, the method comprising: in each repetition, prior to said first processing, preprocessing each object in the plurality of objects using a computationally inexpensive operation and determining if the results of at least one preprocessing in respect of at least one object satisfies a predetermined criteria; and only upon determining that the results of at least one preprocessing of at least one object satisfies a predetermined criteria, thereafter processing each object using the computationally expensive operation and subsequently processing the plurality of objects to determine if the condition is met, and upon determining that the condition is met taking the action; thereby reducing the number of computationally expensive operations required to be performed in one or more repetitions.

In accordance with further aspects and optionally in combination with other aspects, further comprising, upon determining that the condition is not met, revising at least one predetermined criteria in respect of at least one object in accordance with a current state of the at least one object, such that a next preprocessing of any given object in the plurality of objects will not result in a predetermined criteria in respect of the given object being satisfied.

In accordance with further aspects and optionally in combination with other aspects, the plurality of objects is a plurality of trading positions in a respective plurality of financial instruments in a trading portfolio, the plurality of trading positions comprising a basket of trading positions, and the task is to calculate the value of the trading portfolio to determine if a liquidation trigger in respect of the trading portfolio is met, and the action is liquidating the trading portfolio, and repetitively processing the plurality of trading positions comprises repetitively calculating the value of the trading portfolio each time a current price of at least one of the financial instruments is updated.

In accordance with further aspects and optionally in combination with other aspects, said first processing of a given trading position in respect of a given instrument using a computationally expensive operation comprises determining a P&L of the given trading position.

In accordance with further aspects and optionally in combination with other aspects, determining a P&L of the given trading position comprises, determining a current price of the given instrument, determining a difference in price between the current price and a price at the time of opening the position, and multiplying the difference by a number of units traded in the position.

In accordance with further aspects and optionally in combination with other aspects, the computationally inexpensive operation comprises, for a given position in respect of a given instrument, determining a current market price of the instrument, and comparing the market price with a predetermined target price threshold in respect of the given instrument.

In accordance with further aspects and optionally in combination with other aspects, upon comparing the market price with the predetermined target price threshold in respect of the given instrument, the predetermined criteria is met upon the current market price breaching the predetermined target price threshold.

In accordance with further aspects and optionally in combination with other aspects, the predetermined target price threshold for each instrument is determined prior to a given repetition in accordance with at least one of: a volatility of the instrument in a predetermined time period, a size of a position held in respect of the instrument, and a combination thereof.

In accordance with further aspects and optionally in combination with other aspects, the predetermined target price threshold for one or more instruments is revised upon at least one of a trading position in the basket of trading positions being closed, an amount of cash being transferred in or out of the trading portfolio, an amount of cash being transferred in or out of the trading portfolio, a new trading position being opened, and a liquidation trigger being changed.

In accordance with further aspects and optionally in combination with other aspects, the predetermined target price threshold for the one or more instruments is revised such that none of the target price thresholds will be breached in the next repetition.

In accordance with further aspects and optionally in combination with other aspects, the liquidation trigger includes a stop loss, a take profit, a trailing stop loss and a trailing take profit.

in accordance with certain other aspects of the presently disclosed subject matter there is provided a method of facilitating mirror trading of financial instruments in a trading network comprising a plurality of traders, the method comprising, by a processor operatively coupled to a memory: obtaining, from the memory, first criteria received from a copying trader for identifying at least one target trading position opened by at least a first copied trader in respect of at least one instrument to mirror for the copying trader in a mirror portfolio associated with the copying trader; obtaining, from the memory, second criteria received from the copying trader for identifying at least a second trading position in respect of an instrument, said second trading position being either a non-mirror trading position or a target trading position opened by at least a second copied trader different from the first copied trader; identifying at least one target trading position satisfying the first criteria and at least a second trading position satisfying the second criteria, automatically opening, in a mirror portfolio of the copying trader, a basket of trading positions, the basket of trading positions comprising at least a mirror trading position corresponding to the identified at least one target trading position in accordance with the first criteria, and at least a second trading position in accordance with the second criteria; obtaining, from the memory, a stop loss (SL) received from the copying trader to apply to the mirror portfolio; and automatically liquidating the mirror portfolio upon the SL being met.

In accordance with certain other aspects of the presently disclosed subject matter there is provided a system for facilitating mirror trading of financial instruments in a trading network comprising a plurality of traders, the system comprising a processor operatively coupled to a memory and configured to: obtain, from the memory, first criteria received from a copying trader for identifying at least one target trading position opened by at least a first copied trader in respect of at least one instrument to mirror for the copying trader in a mirror portfolio associated with the copying trader; obtain, from the memory, second criteria received from the copying trader for identifying at least a second trading position in respect of an instrument, said second trading position being either a non-mirror trading position or a target trading position opened by at least a second copied trader different from the first copied trader; identify at least one target trading position satisfying the first criteria and at least a second trading position satisfying the second criteria; automatically open, in a mirror portfolio of the copying trader, a basket of trading positions, the basket of trading positions comprising at least a mirror trading position corresponding to the identified at least one target trading position in accordance with the first criteria, and at least a second trading position in accordance with the second criteria; obtain, from the memory, a stop loss (SL) received from the copying trader to apply to the mirror portfolio; and automatically liquidate the mirror portfolio upon the SL being met.

In accordance with certain other aspects of the presently disclosed subject matter there is provided a non-transitory storage medium comprising instructions embodied therein, that when executed by a processor comprised in a computer, cause the processor to perform a method of facilitating mirror trading of financial instruments in a trading network comprising a plurality of traders, the method comprising: obtaining first criteria received from a copying trader for identifying at least one target trading position opened by at least a first copied trader in respect of at least one instrument to mirror for the copying trader in a mirror portfolio associated with the copying trader; obtaining second criteria received from the copying trader for identifying at least a second trading position in respect of an instrument said second trading position being either a non-mirror trading position or a target trading position opened by at least a second copied trader different from the first copied trader; identifying at least one target trading position satisfying the first criteria and at least a second trading position satisfying the second criteria; automatically opening, in a mirror portfolio of the copying trader, a basket of trading positions, the basket of trading positions comprising at least a mirror trading position corresponding to the identified at least one target trading position in accordance with the first criteria, and at least a second trading position in accordance with the second criteria: obtaining a stop loss (SL) received from the copying trader to apply to the mirror portfolio, and automatically liquidating the mirror portfolio upon the SL being met.

In accordance with further aspects and optionally in combination with other aspects, the obtained first or second criteria includes at least an indication of each copied trader, said indication sufficient to discern each copied trader from other traders in the trading network.

In accordance with further aspects and optionally in combination with other aspects, the obtained first or second criteria further includes an indication of one or more of: a specific target trading position, a specific instrument, a specific instrument type, specific position types, and a specific timeframes.

In accordance with further aspects and optionally in combination with other aspects, the obtained first or second criteria further includes an indication that the at least one target trading position is one of: a previously opened target trading position and a not yet opened target trading position.

In accordance with further aspects and optionally in combination with other aspects, the SL is met upon at least one of a portfolio value and a change in a portfolio value breaching a predetermined threshold value.

In accordance with further aspects and optionally in combination with other aspects, liquidating the mirror portfolio further comprises determining if a current value of the mirror portfolio breaches the SL.

In accordance with further aspects and optionally in combination with other aspects, determining if a current value of the mirror portfolio breaches the SL comprises setting a target price threshold for one or more instruments held in one or more trading positions in the basket of trading positions; determining, using a computationally inexpensive operation, if any target price threshold is breached; and upon determining that at least one target price threshold is breached, calculating a current value of the portfolio using one or more computationally expensive operations, and determining if one of: the current value or a change in the current value, breaches the SL.

In accordance with further aspects and optionally in combination with other aspects, the one or more target price thresholds are set such that if all target price thresholds are breached, the SL will be breached.

In accordance with further aspects and optionally in combination with other aspects, the one or more target price thresholds are set for the one or more instruments in accordance with the current prices of each instrument and further in accordance with at least one of: each instruments' respective position size in the portfolio, and each instruments' respective volatility.

In accordance with further aspects and optionally in combination with other aspects, further comprising, upon determining that the current value of the portfolio does not breach the SL, revising one or more of the target price thresholds in accordance with the current prices of the respective one or more target price thresholds such that no target price thresholds are breached.

In accordance with further aspects and optionally in combination with other aspects, the computationally inexpensive operation comprises, for each instrument, obtaining the current price of the instrument, comparing the current price to its respective target price threshold, and determining if the current price breaches the target price threshold.

In accordance with further aspects and optionally in combination with other aspects, the one or more computationally expensive operations comprises, for each trading position P in respect of an instrument, calculating a P&L of P using the formula

P&L_{P}=(p_{c}−p₀)×u

where p_{c} is the current price of the instrument per unit, p₀ is the initial price per unit, and u is the number of units traded in P.

In accordance with further aspects and optionally in combination with other aspects, the current value V of the portfolio is calculated using the formula

$$V = C + {\sum }_{i = 1}^{n} {c}_{i} + {\sum }_{i = 1}^{n} P \& {L}_{i}$$

where C is the cash in the portfolio, cᵢ is the amount the trader has invested in the i-th trading position, and P&Lᵢ is the P&L of the i-th trading position.

In accordance with further aspects and optionally in combination with other aspects, one or more target price thresholds are revised upon a trading position being closed.

In accordance with further aspects and optionally in combination with other aspects, one or more target price thresholds are revised upon a new trading position being opened.

In accordance with further aspects and optionally in combination with other aspects, one or more target price thresholds are revised upon cash being transferred in or out of the portfolio.

In accordance with further aspects and optionally in combination with other aspects, further comprising, upon a copied trader transferring an amount of cash in or out of the copied trader's account, calculating a corresponding amount of cash to transfer in or out of the mirror portfolio, transferring the calculated amount of cash, and revising one or more of the target price thresholds for one or more instruments held in one or more trading positions in the basket of trading positions.

In accordance with certain other aspects of the presently disclosed subject matter there is provided a method of facilitating copy trading of financial instruments, the method comprising, by a processor operatively coupled to a memory: obtaining, from the memory, a copy trading (CT) buy order received from the copying trader, the CT buy order comprising at least an indication of: at least one copied trader portfolio associated with a copied trader, and a trailing stop loss (TSL) value; associating the copying trader with a linked investment (LI) portfolio linked to each at least one copied trader portfolio, executing, in the LI portfolio, one or more first trades in respect of one or more instruments in accordance with the CT buy order, the one or more first trades mirroring one or more trades executed in the linked at least one copied trader's portfolio, monitoring the performance of the LI portfolio; and liquidating the LI portfolio upon the performance meeting a first criteria and revising the TSL value upon the performance meeting a second criteria; wherein the first criteria is met if the performance is indicative of the TSL value being breached, and the second criteria is met if the performance is indicative of a LI portfolio value increase/decrease of a predetermined amount.

### BRIEF DESCRIPTION OF THE DRAWINGS

In order to understand the invention and to sec how it can be carried out in practice, embodiments will be described, by way of non-limiting examples, with reference to the accompanying drawings, in which:

FIG. 1 illustrates an example of a generalized network environment in which a mirror trading system operates, in accordance with certain embodiments of the disclosed subject matter;

FIG. 2 illustrates a generalized functional diagram of a mirror trading system, in accordance with certain embodiments of the presently disclosed subject matter;

FIG. 3 illustrates a generalized flow chart of a sequence of operations carried out for facilitating mirror trading of financial instruments in a trading network, in accordance with certain embodiments of the presently disclosed subject matter;

FIG. 4 schematically illustrates a basket of trading positions in a mirror trading portfolio, in accordance with certain embodiments of the presently disclosed subject matter;

FIG. 5A illustrates an example of a trailing stop loss applied to a mirror portfolio comprising a basket of trading positions, in accordance with certain embodiments of the presently disclosed subject matter;

FIG. 5B illustrates an example of a trailing take profit applied to a mirror portfolio comprising a basket of trading positions, to accordance with certain embodiments of the presently disclosed subject matter;

FIG. 5C illustrates a second example of a trailing take profit applied to a mirror portfolio comprising a basket of trading positions, in accordance with certain embodiments of the presently disclosed subject matter;

FIG. 6 illustrates a generalized flow chart of repeatingly changing a liquidation trigger, in accordance with certain embodiments of the presently disclosed subject matter;

FIG. 7 illustrates a generalized flow chart of monitoring a basket of trading positions and liquidating the basket or closing a position, in accordance with certain embodiments of the presently disclosed subject matter;

FIG. 8A illustrates a generalized flow chart of monitoring a mirror portfolio value in the case of a stop loss liquidation trigger, and liquidating the mirror portfolio or changing the liquidation trigger, in accordance with certain embodiments of the presently disclosed subject matter;

FIG. 8B illustrates a generalized flow chart of monitoring a mirror portfolio value in the case of a take profit liquidation trigger and liquidating the mirror portfolio or changing the liquidation trigger, in accordance with certain embodiments of the presently disclosed subject matter;

FIG. 8C illustrates a generalized flow chart of monitoring a mirror portfolio value in the case of a take profit liquidation trigger and liquidating the mirror portfolio or changing the liquidation trigger, in accordance with certain other embodiments of the presently disclosed subject matter;

FIG. 9 illustrates a generalized flow chart of monitoring a mirror portfolio value and determining if a liquidation trigger is breached, in accordance with certain embodiments of the presently disclosed subject matter;

FIG. 10 illustrates a generalized flow chart of reducing the computational complexity required for a processor to perform a task related to repetitively processing a plurality of objects, in accordance with certain embodiments of the presently disclosed subject matter;

FIG. 11 illustrates a generalized flow chart of reducing the computationally complexity required for a processor to calculate a mirror portfolio value, in accordance with certain embodiments of the presently disclosed subject matter;

FIG. 12 illustrates a first example of setting target price thresholds, in accordance with certain embodiments of the presently disclosed subject matter;

FIG. 13 illustrates a second example of setting target price thresholds, in accordance with certain embodiments of the presently disclosed subject matter.

FIG. 14 illustrates a third example of setting target price thresholds, in accordance with certain embodiments of the presently disclosed subject matter;

FIG. 15 illustrates a generalized flow chart of transferring cash in or out of a portfolio, in accordance with certain embodiments of the disclosed subject matter;

FIG. 16 illustrates a generalized flow chart of a sequence of operations carried out for facilitating mirror trading of financial instruments in a trading network, in accordance with certain embodiments of the presently disclosed subject matter; and

FIG. 17 illustrates a generalized flow chart of a sequence of operations carried out for facilitating mirror trading of financial instruments in a trading network, in accordance with certain embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “calculating”, “associating”, “comparing”, “preprocessing”, “monitoring”, “receiving”, “obtaining”, “revising”, “opening”, “changing”, “generating,” “liquidating” or the like, refer to the action(s) and/or process(es) of a computer that manipulate and/or transform data into other data, said data represented as physical, such as electronic, quantities and/or said data representing the physical objects. The term “computer” should be expansively construed to include any kind of electronic device with data processing capabilities including, by way of non-limiting example, the computer system comprised in the mirror trading system disclosed in the present application.

Reference to a computer or processor taking a certain action should be understood to mean issuing commands that result in the described action being taken.

It is to be understood that the term “non-transitory computer usable medium” is used herein to exclude transitory, propagating signals, but to include, otherwise, any volatile or non-volatile computer memory technology suitable to the presently disclosed subject matter.

The operations in accordance with the teachings herein may be performed by a computer specially constructed for the desired purposes or by a general-purpose computer specially configured for the desired purpose by a computer program stored in a computer readable storage medium.

Embodiments of the presently disclosed subject matter are not described with reference to any particular programming language. It will be appreciated that a variety of programming languages may be used to implement the teachings of the presently disclosed subject mutter as described herein.

In the description dial follows:

“Trading position”, and variants thereof, should be understood to include an open trading position in respect of a given financial instrument (e.g. a purchase of 500 shares of Apple);

“Copying trader” should be understood to include the trader mirroring one or more trading positions of one or more other traders;

“Copied trader” should be understood to include the trader whose one or more trading positions are being mirrored, or is desirous of being mirrored, by a copying trader;

“Minor position”, and variants thereof, should be understood to include a proportional copy trading position copied from another trader (e.g. a copied trader), according to the proportion between the copied trader's portfolio and the copying trader's allotted copying funds. By way of non-limiting example, Bob has $100 in his trading portfolio, and invests half of this amount ($50) to buy shares of XYZ Corp. Andre allots $200 to mirror Bob. Andre's mirror position consists of a purchase of $100 worth of shares of XYZ Corp (being half of the 200$ allotted to mirror Bob's XYZ Corp. trading position). Bob's purchase of shares of XYZ Corp. and Andre's purchase of XYZ Corp. are said to be “corresponding” trading positions.

A mirror position “corresponds” to a trading position, and vice versa, when the mirror position is a copy trading position based on the corresponding trading position;

A “target trading position” is a trading position to mirror, or a trading position having been mirrored. It should be noted that a target trading position can itself be a mirror position corresponding to a different target trading position;

“P&L” (Profit and Loss) of a trading position (including a mirror position) in respect of a financial instrument should be understood to include the (unrealized) gain or loss incurred in the trading position at a point in time, and can be calculated as

P&L_{P}=(p_{c}−p₀)×w

where p_{c} is the current price of the instrument per unit, p₀ is the initial price per unit (i.e. the price at which the trading position was opened), and u is the number of units traded. For example, suppose Bob's $50 bought him 20 shares of XYZ Corp. for $2.50 per share. A week later, the share prices rises to $4.50. The P&L of Bob's position in XYZ Corp. is $40 (i.e. (4.50−2.50)×20);

“Portfolio” should be understood to include at least one investment portfolio associated with a given trader, each investment portfolio including investments in financial instruments (including without limitation, e.g. stocks, bonds, commodities, currencies, etc.) and, optionally, cash. A portfolio can be e.g., one or more investment accounts or investment sub-accounts, etc. A portfolio can also be a virtual collection of a number of discrete investment portfolios or investment accounts. A “mirror portfolio” should be understood to include a portfolio designated for holding mirror positions (though in some embodiments it may also hold non-mirror positions).

“Cash” should be understood to include non-invested trading funds in a portfolio;

“Portfolio value” should be understood to include the amount of cash that the trader can be expected to be left with if the portfolio is liquidated. Portfolio value V can be calculated as the total cash C in the portfolio, plus the invested cash in each trade cᵢ, plus the sum of P&L of each trading position as given by the formula:

$$V = C + {\sum }_{i = 1}^{n} {c}_{i} + {\sum }_{i = 1}^{n} P \& {L}_{i}$$

For example, in the example detailed above, Bob's portfolio value is calculated as $30−$50−$40 (the total cash remaining after the investment in XYZ Corp.+the cash invested in XYZ Corp.+the P&L of the trade in XYZ Corp.) for a portfolio value of $140;

“Liquidation trigger” should be understood to include a specified condition for automatically liquidating a portfolio.

“Breach” should be understood to include meet and/or exceed;

“Criteria” should be understood to include one or more criterions and combinations thereof; including, e.g. compound criterions; and

“Basket of trading positions”, and variants thereof should be understood to include one or more separate trading positions virtually aggregated in a portfolio and capable of being traded as a unit.

It should be noted that the above definitions are provided in order to better understand the description herein and, where used in the claims, are not intended to limit the claimed term(s) to the definition provided above.

As used herein, the phrase “for example,” “such as”, “for Instance” and variants thereof describe non-limiting embodiments of the presently disclosed subject matter. Reference in the specification to “one embodiment”, “some embodiments”, “certain embodiments” or variants thereof means that a particular feature, structure or characteristic described in connection with the embodiment(s) is included in at least one embodiment of the presently disclosed subject matter. Thus the appearance of the phrase “one embodiment”, “some embodiments”, “certain embodiments” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

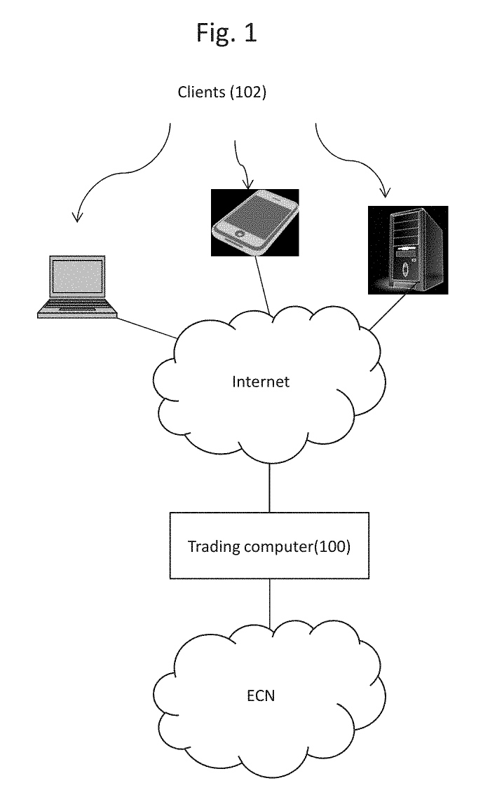

Bearing this in mind, attention is drawn to FIG. 1, illustrating a non-limiting example of a generalized network environment in which a mirror trading system operates in accordance with certain embodiments of the disclosed subject matter.

According to some examples of the presently disclosed subject matter, the mirror trading system can include a trading computer (100) operatively coupled to one or more trading client devices (102), e.g. via the Internet. Trading computer (100) receives trading instructions, including mirror trading instructions, from traders registered with the trading system and operating client devices (102). Trading computer (100) opens and/or closes trading positions, including mirror trading positions, on behalf of traders in accordance with the received trading instructions by communicating trading orders to a trading exchange or trading network, such as the illustrated electronic communication network (ECN), for execution. Trading computer (100) can also receive trade confirmations from the ECN, and transfer trade confirmations to the client devices (102). It is to be noted that in certain embodiments, trading computer (100) can open and close trading position without communicating with an ECN. For example, trading computer (100) can itself act as the ECN.

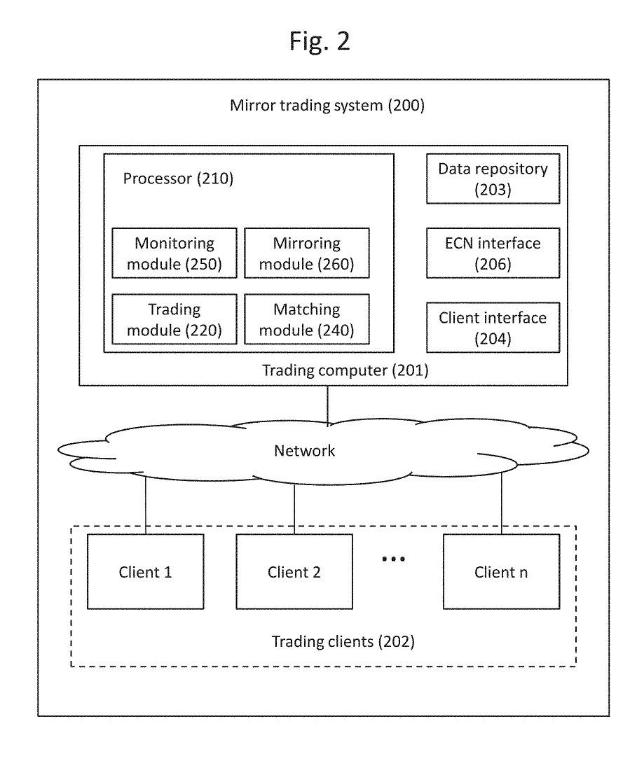

FIG. 2 illustrates a generalized functional diagram of a mirror trading system in accordance with certain embodiments of the presently disclosed subject matter. In certain embodiments, mirror trading system (200) can comprise a trading computer (201) (e.g. a trading server) operatively coupled to one or more trading clients (202) over a data communication network, such as a wired network, wireless network, or combined wired and wireless network (including, e.g. a cloud environment such as the Internet). Trading computer (201) can comprise or be coupled to one or more processors (210). The one or more processors (210) can be, e.g., a processing unit, a micro processor, a microcontroller or any other computing device or module, including multiple and/or parallel and/or distributed processing units, which are adapted to independently or cooperatively process data for controlling relevant computer (201) resources and for enabling operations related to computer (201) resources.

In certain embodiments, computer (201) can further comprise a client interface (204) (e.g. a network interface card or any other suitable device) for enabling computer (201) components to communicate with clients (202). Client interface (204) may include a network interface card or other suitable device for enabling communication with client devices. In certain embodiments, client interface (204) can be configured to receive trading instructions from one or more clients (202), including, e.g., criteria for mirroring trading positions of one or more copied traders and/or one or more liquidation triggers, etc. In certain embodiments, client interface (204) can be configured to transfer the received trading instructions to other components of the system, including, e.g., processor (210) and/or data repository (203).

In certain embodiments, computer (201) can further comprise an exchange interface (206) for enabling computer (201) components to communicate trading orders to trading exchanges or ECNs in those embodiments where computer (201) communicates with a trading exchange or ECN.

In certain embodiments, computer (201) can comprise (or be otherwise associated with) one or more memories, such as the illustrated data repository (203), configured to store data including, inter alia, data related to a trading network comprising a plurality of traders. By way of non-limiting example, data repository (203) can be configured to store data informative of traders and their respective trading accounts and portfolios (and the contents thereof), and trading instructions received from a trader. In certain embodiments, data repository (203) can store data indicative of objects (including, e.g., trading positions in respect of financial instruments), and other values (including, e.g., thresholds, liquidation triggers, etc.), as will further be detailed below.

In certain embodiments, the processor (210) can include (or be otherwise associated with) one or more of the following modules: trading module (220), matching module (240), monitoring module (250), and mirroring module (260).

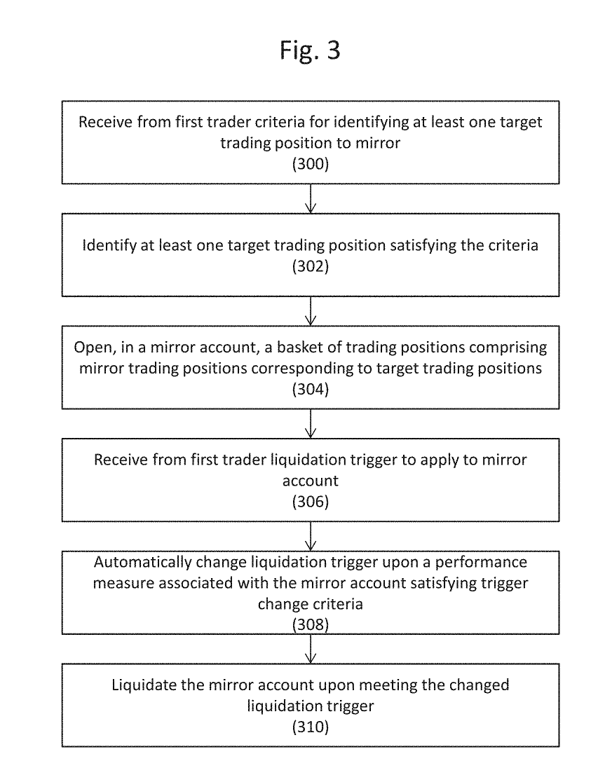

In certain embodiments, the trading module (220) can be configured to obtain (e.g. from one or more other components of system (200)) data indicative of one or more trading orders to generate and execute, or optionally to transfer to an exchange or ECN for execution (e.g. via exchange interface (206)). In certain embodiments, the trading module (220) can be configured to automatically open and/or close one or more trading positions, as further detailed below with reference to FIG. 3, illustrating a generalized flow chart of a sequence of operations carried out for facilitating mirror trading of financial instruments in a trading network. In certain embodiments the trading module (220) can generate one or more trading orders for automatically liquidating a basket of trading positions, as further detailed below with reference to FIG. 3, illustrating a generalized flow chart of a sequence of operations carried out for facilitating mirror trading of financial instruments in a trading network.

In certain embodiments, the matching module (240) can be configured to obtain (e.g. from one or more other components of system (200)) data indicative of criteria received from a copying trader for identifying a target trading position of a copied trader to mirror for the copying trader, and identifying a target trading position satisfying the criteria, as will further be detailed with reference to FIG. 3, illustrating a generalized flow chart of a sequence of operations carried out for facilitating mirror trading of financial instruments in a trading network.

In certain embodiments, the mirroring module (260) can be configured to obtain (e.g. from one or more other components of system (200)) data indicative of a target trading position, and to generate data indicative of a mirror trading position that corresponds to the target trading position.

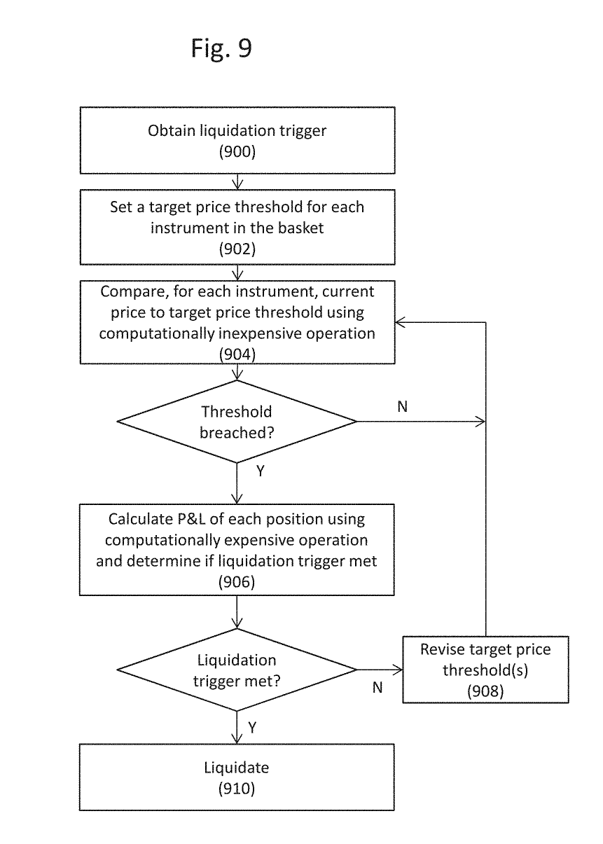

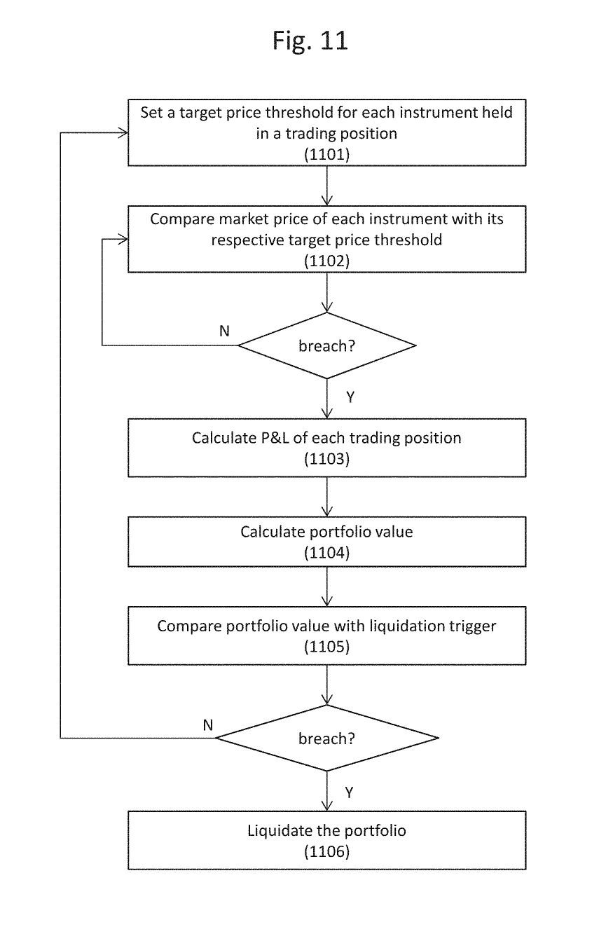

In certain embodiments, the monitoring module (250) can be configured to monitor a trading portfolio, e.g. a mirror trading portfolio, and to generate data indicative of a performance measure of the trading portfolio. In certain embodiments, the monitoring module (250) can be configured to compare a given performance measure to a given liquidation trigger and/or to change the liquidation trigger. In certain embodiments, the monitoring module (250) can set, revise and/or compare one or more target price thresholds, as will further be detailed below with reference to FIGS. 9 and 11.

Having described the system, attention is now drawn to FIG. 3, illustrating a generalized flow chart of an example of a sequence of operations carried out for facilitating mirror trading of financial instruments in a trading network comprising a plurality of traders, in accordance with certain embodiments of the presently disclosed subject matter.

Referring now to FIG. 3, according to some examples of the presently disclosed subject matter, system (200) can be configured to facilitate mirror trading of financial instruments in a trading network by automatically liquidating a mirror portfolio in response to a changed liquidation trigger being met. System (200) can receive (300) from a copying trader criteria for identifying at least one target trading position opened by at least one copied trader, in respect of at least one financial instrument, to mirror for the copying trader in a mirror portfolio associated with the copying trader. For example, the received criteria can be received at client interface (204) and transferred to data repository (203). System (200) can then obtain the criteria from data repository (203).

In certain embodiments, the criteria for identifying at least one target trading position opened by at least one copied trader can include criteria for identifying at least two target trading positions opened by a respective at least two different copied traders, each in respect of at least one financial instrument, to mirror for the copying trader.

In certain embodiments, the criteria can include parameters for opening one or more regular (i.e. non-mirror) trading positions for the copied trader in the mirror portfolio, using trading funds allotted for that purpose. For example, the parameters can include such things as a description of a financial instrument, a position type, an investment amount, a leverage amount, etc.

In certain embodiments, the criteria can include information sufficient to discern the copied trader(s) from other traders in the trading network. For example, the criteria can be a username (or other identifying details) of a given trader that identifies the given trader in the trading network (e.g. “guru4”). In certain embodiments, the criteria can also include other criteria for identifying target trading positions to mirror. By way of non-limiting example, in certain embodiments, the copying trader may want to mirror all trading positions of trader “guru2”, or all trading positions of traders “guru2” and “guru4”, or certain trading positions of “guru2”, or certain trading positions of “guru2”* and all trading positions of “guru4”, etc. Therefore, the criteria can include information sufficient to discern specific target trading positions, e.g. specific instrument(s) (e.g. “shares of XYZ Corp.”, “oil”, etc.), specific instrument type(s) (e.g. stocks, options, commodities, currencies, etc.), specific position type(s) (e.g. buys, short sells, etc.), specific timeframes (including. e.g., specific date(s) or data range(s) when the target trading position is opened, etc.) and the like.

In certain embodiments, the copying trader may want to mirror trading positions of the copied trader(s) already opened by the copied trader (i.e. in the past). In certain embodiments, the copying trader may want to mirror only trading positions not yet opened by the copied trader(s) (i.e. future trading positions). In certain embodiments, the copying trader may want to mirror past and future trading positions of a given one or more copied trader. Therefore, in certain embodiments, the criteria obtained from the copying trader can also include information indicative of whether the target trading positions include only trading positions already opened by the copied trader(s), future trading positions not yet opened by the copied trader(s), or both. By way of non-limiting example, copying trader Andre can input to the mirror trading system instructions to mirror all future trades of Bob in Oil and Gold. To that end. Andre transfers $500 to a mirror trading portfolio for mirroring Bob's future Oil and Cold trades.

In certain embodiments, system (200) can be configured (e.g. using matching module (240)) to identify (302) at least one target trading position opened by at least one copied trader that satisfies the criteria. For example, the mirror trading system can detect that Bob opened two trading positions, one in Oil and the other in Gold. Bob used 20% of his trading funds to buy Oil, and a further 10% to sell short Gold. Based on the criteria received from Andre, the mirror trading system can identify Bob's trading positions in Oil and Gold as target trading positions to mirror for Andre. As used herein, a trading position opened “by” a given trader includes a trading position opened on behalf of the given trader, for example a trading position opened for the given trader automatically by system (200) in accordance with trading instructions (including, e.g. mirror trading instructions) received from the given trader.

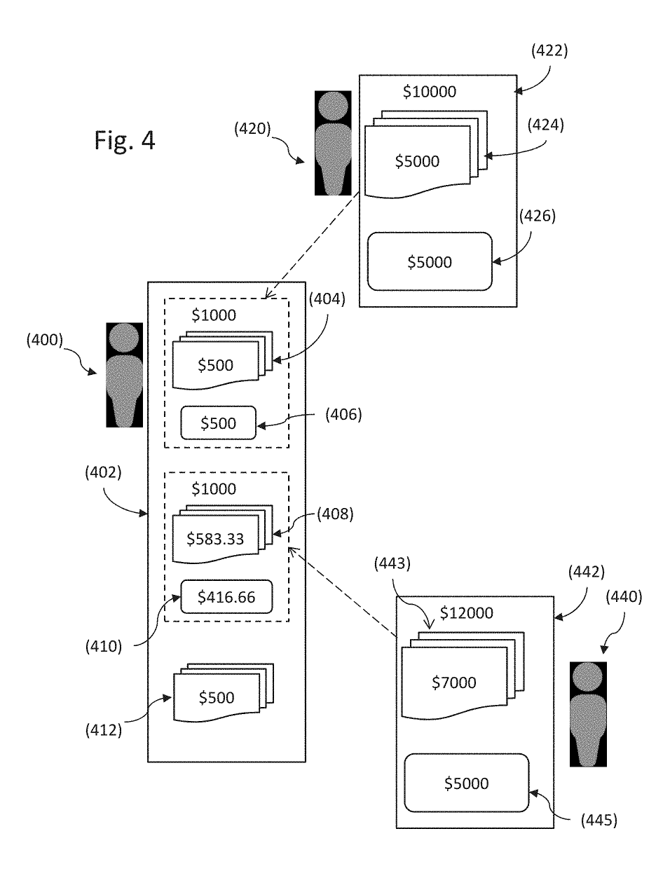

In certain embodiments, system (200) can be configured (e.g. using trading module (220)) to open (304), in a mirror trading portfolio associated with the copying trader, a basket of trading positions comprising one or more mirror trading positions, each mirror position corresponding to an identified target trading position, as will further be detailed with reference to FIG. 4, schematically illustrating a basket of trading positions, in accordance with certain embodiments of the presently disclosed subject matter. For example, the mirror trading system can open, in Andre's mirror portfolio (using the $500 Andre transferred in the purpose) a basket of trading positions comprising a purchase m Oil using $100 (500×20%), and a short sale of Gold using $50 (500×10%), both positions mirrored from Bob using a proportional amount of trading funds.

In certain embodiments, prior to opening the one or more mirror positions, system (200) can be configured (e.g. using mirroring module (260)) to generate, for each identified target trading position, a corresponding mirror trading position to open for the copying trader, e.g. by calculating the proportional mirror trade based on the allotted funds, as detailed above. For example, the mirror trading system can calculate the amount of Andre's trading funds to be used in the Oil purchase and Gold sale.

In certain embodiments, the basket of trading positions can include one or more identified non-mirror trading positions in accordance with received trading instructions, as detailed above.

In certain embodiments, system (200) can receive (306) from the copying trader one or more liquidation triggers to apply to the mirror portfolio which, if met, results in system (200) automatically liquidating the mirror portfolio, by liquidating (i.e. closing) all trading positions in the basket of trading positions. For example, the received one or more liquidation triggers can be received at client interface (204) and transferred to data repository (203). System (200) can then obtain the one or more liquidation triggers from data repository (203).

By way of non-limiting example, a liquidation trigger can be met, e.g., upon the portfolio's value breaching a predetermined threshold value, or a change in the portfolio's value breaching a predetermined threshold change in value. In certain embodiments, the change in value can be, e.g., an absolute change in value (e.g. +$100, −$50, etc.) or a relative change in value, e.g. relative to an initial value, that being the value before the basket of trading positions were opened (e.g. +10%, −5%, etc.). In certain embodiments, a liquidation trigger can be met, e.g., upon the value of one or more trading positions in the basket of trading changing by a predetermined amount (including, e.g., a fixed amount or a relative (i.e. percentage) amount). In certain embodiments, the predetermined amount can be recalculated (e.g. in a similar manner to the initial calculation) if trading positions are closed (or new trading positions are opened).

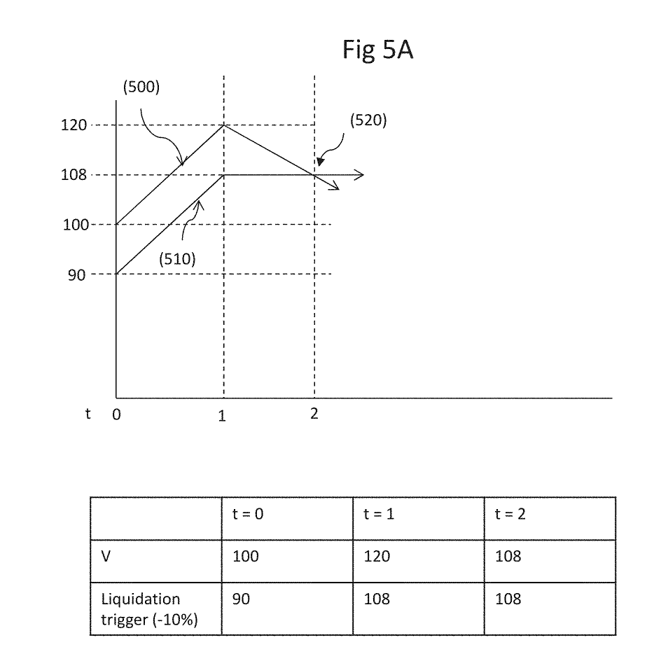

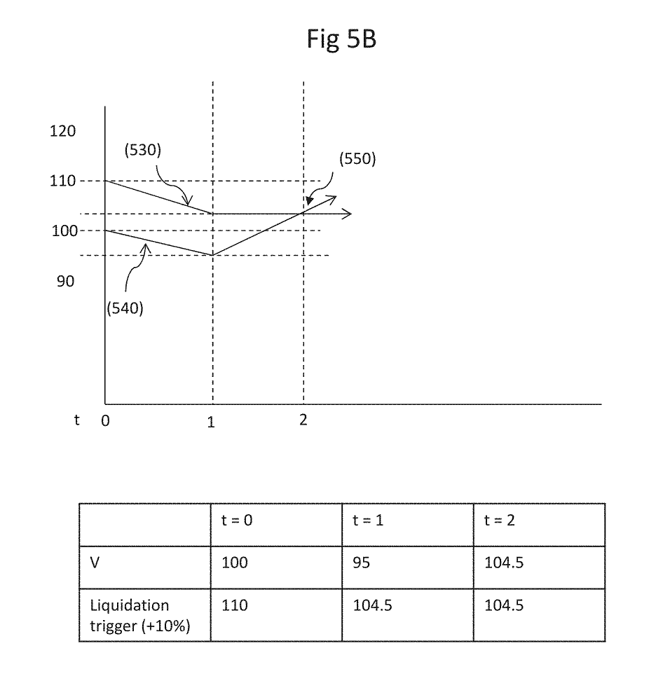

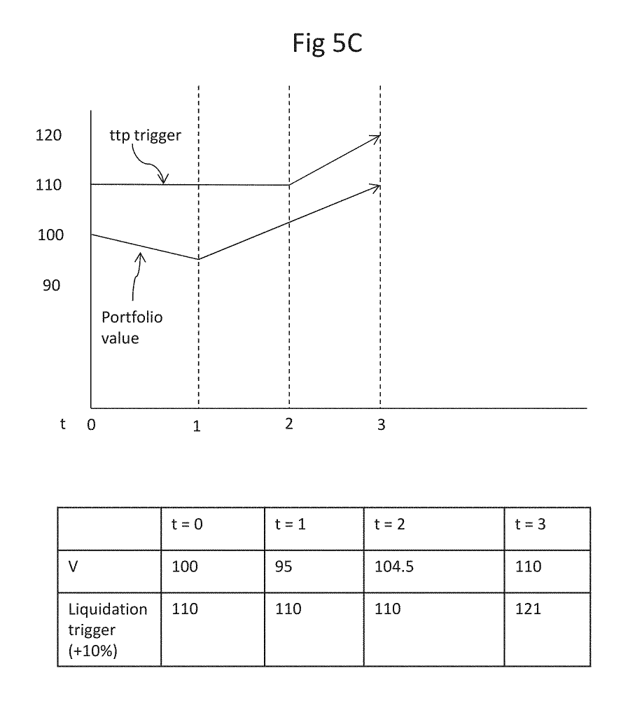

In certain embodiments, the liquidation trigger can be, e.g. a stop loss, a trailing stop loss, a take profit, or a trailing take profit trigger, as further detailed below with reference to FIG. 5A (stop loss) and FIG. 5B (take profit) and FIG. 5C (take profit). For example, Andre can input to the mirror trading system a trailing stop loss of 15% for the mirror portfolio, thereby instructing the mirror trading system to liquidate the mirror portfolio once he loses $75 (500×15%).

In certain embodiments, as will be further detailed below with reference to FIG. 9 and FIG. 11, system (200) can set (e.g. using monitoring module (250)) one or more price target thresholds for one or more instruments held in the basket of trading positions, in accordance with the received one or more liquidation triggers.

In certain embodiments, system (200) can (e.g. using monitoring module (250)) monitor a performance measure indicative of performance of the mirror portfolio, e.g. a portfolio value, a change in the portfolio value (including, e.g., absolute or relative) from a prior portfolio value, such as the initial value, etc.

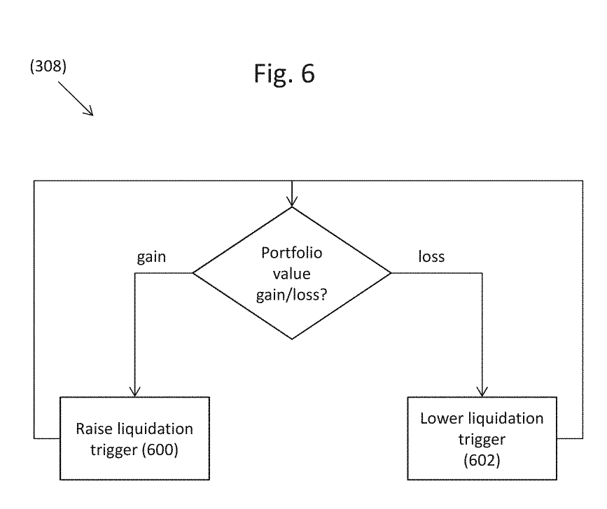

In certain embodiments, system (200) can (e.g. using monitoring module (250)) change (308) at least one liquidation trigger upon the performance measure of the mirror portfolio satisfying one or more trigger change criteria, as will further be detailed below with reference to FIG. 6. For example, Andre's mirror position in Oil goes up from $100 to $220, while his position in Gold goes down from $50 to $30. As a result his portfolio gains $100 (120−20) and rises in value from $500 to $600. Accordingly, the mirror trading system can raise the trailing stop loss. e.g. to liquidate once he loses 15% of $600 ($90) or another amount, e.g., based on predetermined trigger change criteria.

In certain embodiments, as will be further detailed below with reference to FIG. 9 and FIG. 11, system (200) am revise (e.g. using monitoring module (250)) one or more price target thresholds for one or more instruments held in the basket of trading positions, in accordance with the changed one or more liquidation triggers.

In certain embodiments, system (200) can (e.g. using trading module (220)) liquidate (310) the mirror portfolio upon the changed liquidation trigger being met, by liquidating the basket of trading positions. For example, in Andre's mirror portfolio Oil stays at $220, while Gold goes to $−60 (minus 60, being a short position), for a portfolio value of $510 (i.e. $350 (cash)+$220 (Oil)−$60 (Gold)). The changed liquidation trigger (being $510, as indicated above) is met, so the mirror trading system can liquidate the mirror portfolio by closing Andre's positions in Oil and Gold. In certain embodiments, system (200) can determine whether the changed liquidation trigger is met using a method for reducing the computational complexity required for the task, as will further be detailed below with reference to FIGS. 9 and 11.

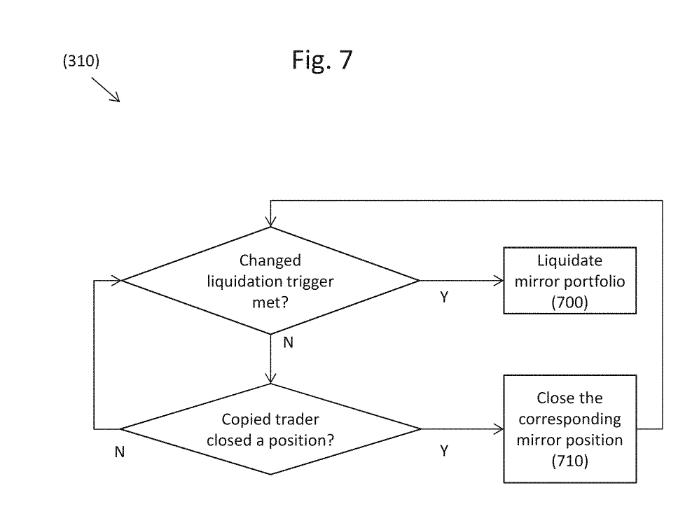

In certain embodiments whether a liquidation trigger is met or not met, system (200) can (e.g. using monitoring module (250)) continuously monitor one or more trading positions corresponding to a respective one or more mirror trading positions in the basket, and close a mirror trading position (e.g. without liquidating the basket) in response to detecting the corresponding trading position being closed, as will further be detailed with reference to FIG. 7. For example, had Andre's mirror portfolio instead risen to $700, and Bob closes his position in Oil, the mirror trading system can automatically close Andre's mirror position in Oil.

In certain embodiments, as will be further detailed below with reference to FIG. 9 and FIG. 11, system (200) can revise (e.g. using monitoring module (250)) one or more price target thresholds for one or more instruments held in the basket of trading positions, in accordance with the received one or more liquidation triggers.

Referring now to FIG. 4, an example (non-limiting) of a mirror portfolio comprising a basket of trading positions is provided. FIG. 4 schematically illustrates a basket of trading positions in a mirror trading portfolio in accordance with certain embodiments. Copying trader “A” (400) transfers $1000 from his regular portfolio to his mirror portfolio (402) to mirror trading positions (424) of copied trader “B” (420). Unbeknownst to trader A (400), trader B's (420) trading portfolio (422) has a portfolio value of $10,000 of which $5000 is invested in the target trading positions (424) which trader A wants to mirror, and $5000 held in cash (426). Since trader A has allocated $1000 for mirroring B's trading positions (424), the mirror trading system automatically opens, in A's mirror portfolio (402), a basket of mirror trading positions (404) corresponding to B's trading positions (424) using half of A's allotted trading funds for mirroring B, so that the 50/50 split between the funds invested in the trading position and the funds held in cash is maintained. The remainder of the allotted funds are held in cash (406) in A's mirror portfolio (402). In certain embodiments, the cash portion of the allotted funds can be “frozen” (i.e. unavailable for A to use on other trades), for reasons of margin maintenance, or to replicate copied trader's investment returns in the mirror account, etc. It should be noted that in certain embodiments, the copying trader can choose to mirror only future trading positions opened by trader B, in which case a mirror trading position can be opened for the copying trader in the same proportion. For example, assume trader A chooses to mirror future trades made by trader B in Oil, and has allotted $10,000 for that purpose. Trader B has an existing portfolio having a portfolio value of $100,000 (including cash). Trader B invests $4000 in a trading position in OIL. The system can automatically open a mirror position in OIL for trader A using $400 of trader A's allotted $10,000 (100,000/4000=10000/400).

Optionally, trader A (400) can concurrently mirror trader “C” (440) in A's mirror trading portfolio (402) using specifically allotted mirror trading funds different from the mirror trading funds allotted to B. In FIG. 4, trader A (400) now transfers an additional $1000 for mirroring trades of trader C (440). Trader C's (440) trading portfolio (442) has a portfolio value of $12,000 of which $7000 is invested in the trading positions (443) which trader A wants to mirror. The remaining $5000 is held by trader C (440) in cash (445). Since trader A has allocated $1000 for mirroring C's trading positions (443), the mirror trading system automatically adds to A's basket of trading positions (404) mirror trading positions (408) corresponding to C's trading positions (443) using 7/12 of A's allotted $1000 for mirroring C (=$583.33). The remainder is held in cash (410) in A's mirror portfolio (402), so that the split between the funds invested in the trading position and the funds held in cash is maintained. A's basket of trading positions now consists of mirror positions (404) and mirror positions (408). As noted above, the same proportion can also be maintained in the event that the copying trader chooses to mirror only future trading position.

In certain embodiments, as detailed above, system (200) can enable trader A (400) to open one or more regular (i.e. non-mirror) trading positions (412) in his mirror portfolio (402) using trading funds allotted for that purpose, and to add the non-mirror trading position(s) to A's basket of trading positions, so that A's basket now comprises trading positions (404), (408) and (412). In addition to A's basket of trading positions, A's mirror portfolio (402) also contains cash components (406) and (410).

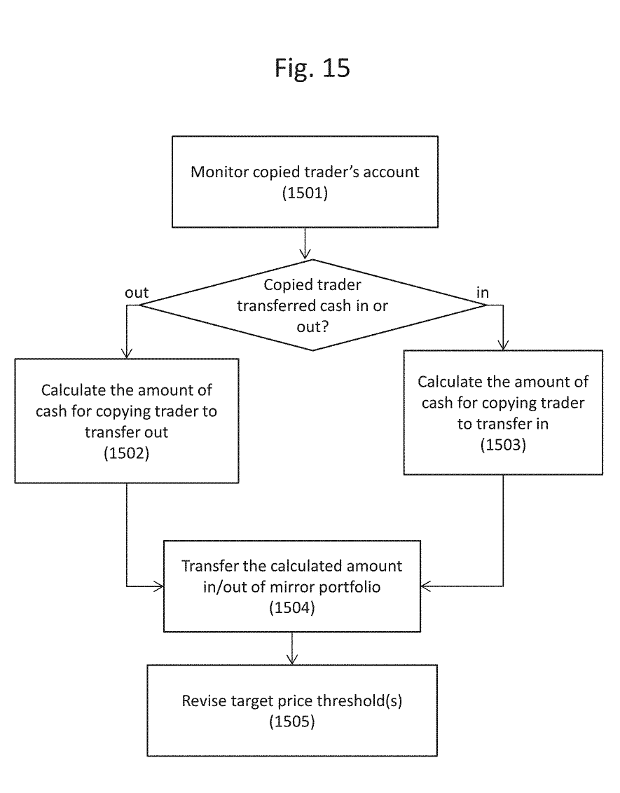

In certain embodiments, in the event that trader B and/or trader C withdraw some of their cash, or deposit additional cash, the mirror trading system can facilitate a corresponding change to be made to A's cash position, as will be further detailed below with reference to FIG. 15.

In order to better understand the disclosed subject matter, there is now provided further details of the liquidation trigger, in accordance with certain embodiments. As detailed above, in certain embodiments, the liquidation trigger can be, e.g. a stop loss, a trailing stop loss, a take profit, or a trailing take profit trigger. Stop loss and take profit triggers are known in the art. A stop loss trigger can be set at a price below (or above, e.g., in the case of short sale) the current price of an instrument and is designed to limit an investor's loss on a position by automatically closing the position when the price reaches the trigger price. A take profit trigger can be set at a price above (or below, e.g., in the case of a short sale) the current price and is designed to automatically lock in a profit when the price reaches the trigger price.

Trailing stop loss and trailing take profit triggers are known in the art, and are, respectively, a stop loss and take profit in which the trigger price (i.e. the price at which to close the position) automatically adjusts according to the price of the instrument. For example, the trigger price can trail (in the case of a trailing stop loss) or lead (in the case of a trailing take profit) the current price (e.g. by a fixed percentage or fixed dollar amount) so long as the current price is moving in the right direction (i.e., the direction which makes a trading profit). A trailing stop loss can be used, for example to protect gains by enabling a trade to remain open and continue to profit as long as the price is moving in the right direction, while automatically closing the trade if the price changes direction by a specified percentage or dollar amount. A trailing take profit can be used, for example, to set a closing price higher than the current price (in the case of a long position, or a lower price in the case of a short position) which is continuously adjusted upwards (in the case of with a long position, or downward in the case of a short position) in lockstep with the current price of the instrument (as illustrated in FIG. 5C below). This implementation of the trailing take profit can be used to lock in gains, e.g. in the event of a sudden price movement. A trailing take profit can also be used, for example, to automatically lower the trader's expected gain on the trade in the event the price moves in the wrong direction before reversing and moving in the right direction (as illustrated in FIG. 5B below).

FIG. 5A illustrates a non-limiting example of a trailing stop loss applied to a mirror portfolio comprising a basket of trading positions, where the trader has specified a trailing stop loss of −10% (i.e. trigger is activated when the portfolio value falls 10%). At time t=0, the mirror portfolio value (500) is $100. Therefore, the trailing stop loss trigger (510) is automatically set at an initial level of $90 (100−10%). At time t=1, the portfolio value (500) has risen to $120 for a gain of 20%. Therefore, the trailing stop loss is automatically raised 20% from $90 to $108 so that the trailing stop toss remains 10% lower than the portfolio value. At time t=2. the portfolio value (520) falls to $108, at which point the mirror trading system automatically liquidates the portfolio for breaching the changed liquidation trigger. It should be noted that in some cases the trailing stop loss can be specified in absolute dollar value loss instead of a percentage loss. For example, in the above scenario the trader can specify a trailing stop loss of −$10 (corresponding to a portfolio value of $90). At t=1, when the portfolio value has reached $120, the trailing stop loss can be automatically raised to $110 ($120−$10), triggering liquidation as soon as the portfolio value falls to $110.

FIG. 5B illustrates a non-limiting example of a trailing take profit applied to a mirror portfolio comprising a basket of trading positions and optionally cash, where the trader has specified a trailing take profit of +10% (i.e. trigger is activated when the portfolio value rises 10%). In this example, the trailing take profit is lowered when the value of the mirror portfolio declines in value. At time t=0, the mirror portfolio value (530) is $100. Therefore, the trailing take profit (540) is automatically set at an initial level of $110 (100+10%) At time t=1, the porttblio value (530) falls to $95 for a loss of 5%. Therefore, the trailing take profit is automatically lowered from $110 to $104.5 (110−5%) so that the trailing take profit remains 10% higher than the portfolio value. At time t=2, the portfolio value (550) rises to $104.5, at which point the mirror trading system automatically liquidates the portfolio for breaching the changed liquidation trigger. Again it should be noted that in some cases the trailing take profit can be specified in absolute dollar value gain instead of a percentage gain For example, in the above scenario the trader can specify a trailing take profit of +10 (corresponding to a portfolio value of $110). At t=1, when the portfolio value is $95, the trailing take profit can be automatically lowered to $105 ($95+$10), triggering liquidation as soon as the portfolio value reaches $105.

FIG. 5C illustrates a second example of a trailing take profit using the same initial condition as in FIG. 5B. In this example, the trailing take profit trigger is only raised and not lowered. At time t=1, when the portfolio value has fallen to $95 for a loss of 5%, the trailing lake profit remains unchanged at $110. At time t=2, when the portfolio value rises to $104.5, the portfolio is not liquidated since the trailing take profit of $110 has not been met. At time t=3, the portfolio value rises to $110, causing the trailing take profit to rise to $121 ($110+10%). It should be noted that in the example illustrated in FIG. 5C, the trailing take profit order is only executed in the event of a sudden jump in price to at or above the trigger price.

It should be noted that in certain embodiments, if the trader inputs a liquidation trigger as a relative value (i.e. a percentage), the system can automatically convert the relative value to a fixed value for comparing to the portfolio value. In some cases, the trader can input the liquidation trigger as a fixed value (e.g. $100, $90, 25 pips, etc.). In certain embodiments, the liquidation trigger can be automatically changed such that the difference between the portfolio value and the liquidation trigger (either in terms of percent or fixed value) remains constant based on the relative or fixed difference. By way of non-limiting example of a fixed value trigger change, if the portfolio value is initially $100 and a liquidation trigger is input at $90 (or, e.g., −$10), and thereafter the portfolio value rises to $120, the system can automatically change the liquidation trigger to $110, e.g. in the case of a trailing stop loss liquidation trigger. By way of a further non-limiting example, if the portfolio value is initially $100 and a liquidation trigger is input as −10%, the system can assign a fixed value liquidation trigger of −$10, being −10% of the current portfolio value. Thereafter, if the portfolio value rises to $120, the system can automatically change the liquidation trigger to $110 ($120−$10) in keeping with the system-assigned fixed value liquidation trigger. It is to be noted that there are many other possibilities for liquidation triggers, and the invention is not bound by the examples of fixed value triggers and relative value triggers provided above.

FIG. 6 illustrates a generalized flow chart of changing a liquidation trigger in accordance with certain embodiments. System (200) can (e.g. using monitoring module (250)), determine (including, e.g. repeatingly) a gain or a loss in performance measure of the mirror portfolio comprising a basket of trading positions. In certain embodiments, upon the system determining a gain in the performance measure of at least a predetermined amount, the system can automatically raise the liquidation trigger (600). In certain embodiments, upon the system determining a loss in the performance measure of at least a predetermined amount, the system can automatically lower the liquidation trigger (602). It should be noted that in certain embodiments, the system can also lower the liquidation trigger in response to a predetermined gain in the performance measure, and raise the liquidation trigger in response to a loss in the performance measure.

In certain embodiments, the system can change the liquidation trigger in accordance with predetermined trigger change criteria, as will be further detailed. For example, the trigger change criteria can specify one or more predetermined rules for changing the liquidation trigger. For example, the trigger change criteria can specify that the liquidation trigger is to be changed in predetermined increments (e.g. $1, $5, etc.), in a predetermined direction (e.g. increase only, decrease only, increase and/or decrease), in response to specific performance measure landmarks (e.g. $10 gain, 5% loss, etc.) and the like. In certain embodiments, the rules can be predetermined by the copying trader. In certain embodiments the rules can be predetermined by the system. In certain embodiments, the system (200) can automatically raise the liquidation trigger in response to determining (e.g. using monitoring module (250)) a mirror portfolio value increase of a predetermined threshold.

Some non-limiting examples of changing the liquidation trigger in accordance with trigger change criteria will now be provided. As a first example, an initial mirror portfolio value is $100, with an initial liquidation trigger set at a loss of 10%, corresponding to value of $90. The trigger change criteria can specify, inter alia, that the liquidation trigger is to be raised upon the mirror portfolio value breaching a predetermined threshold of $110, and is to be raised in equal proportion to the gain in the portfolio value. The mirror portfolio performs well and its value increases to $110 (+10%), breaching the trigger change threshold. In response, the liquidation trigger is raising from $90 to $99 (+10%).

As a second example, the initial mirror portfolio value is $100, with an initial liquidation trigger set at 10% gain corresponding to a value of $110. The trigger change criteria can specify, inter alia, that the liquidation trigger is to be lowered upon the mirror portfolio value breaching a predetermined threshold of $95, and lowered in equal proportion to the decline in the portfolio value. The mirror portfolio performs poorly and its value decreases to $95 (−5%), breaching the trigger change threshold. In response, the liquidation trigger is lowered from $110 to $104.5 (−5%).

In certain embodiments, as detailed above, system (200) can repeatingly change the liquidation trigger upon satisfying one or more trigger change criteria. For example, the liquidation trigger can be automatically changed by initially either raising or lowering the liquidation trigger, and subsequently changed again by either raising or lowering the liquidation trigger. In certain embodiments, the trigger change criteria which must be met for the first liquidation trigger change can be the same or different trigger change criteria which must be met for the subsequent liquidation trigger change. By way of non-limiting example, the initial mirror portfolio value is $100. The initial liquidation trigger is set for 10% loss in value corresponding to a value of $90. The mirror portfolio performs well and its value increases to $110, satisfying a first trigger change criteria, and the system raises the liquidation trigger from $90 to $99 (+10%). The portfolio value then performs poorly and its value decreases from $110 to $105 (˜−4.5%), satisfying a second trigger change criteria and the system lowers the liquidation trigger from $99 to $94.50 (˜−4.5%).

In certain embodiments, as will be further detailed below with reference to FIG. 9 and FIG. 11, system (200) can revise (e.g. using monitoring module (250)) one or more price target thresholds for one or more instruments held in the basket of trading positions, in accordance with the changed liquidation trigger.

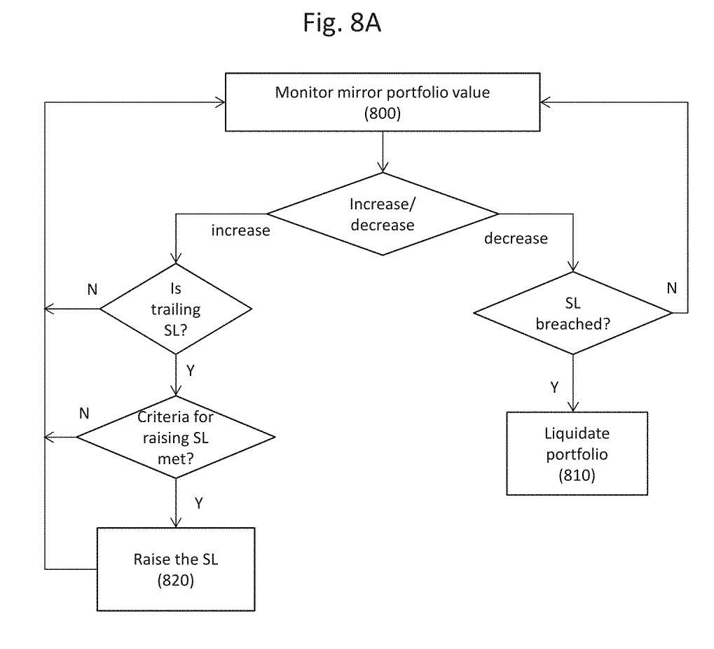

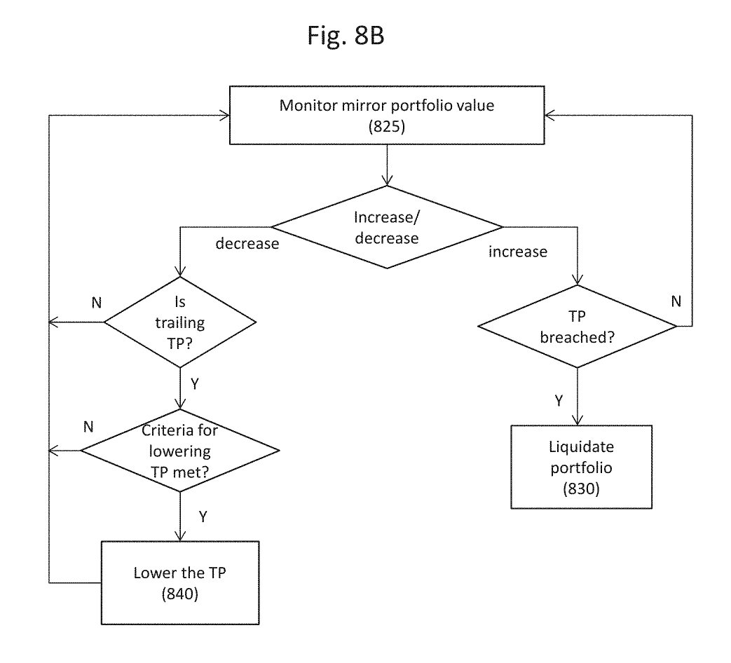

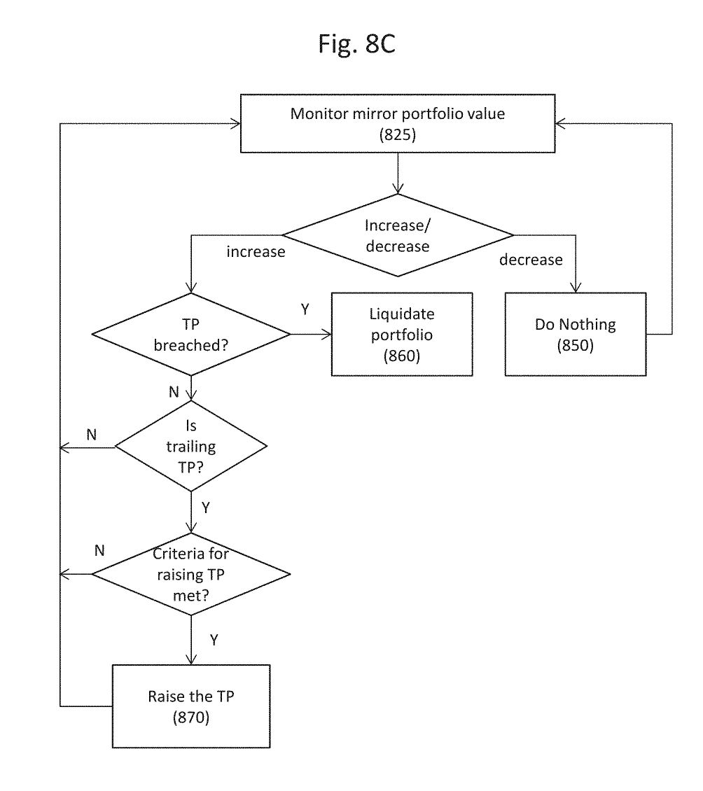

There is now provided further details of liquidating (310) the portfolio, in accordance with certain embodiments. Reference is made to FIG. 7, illustrating a generalized flow chart of monitoring a basket of trading positions and liquidating the basket or closing a position, in accordance with certain embodiments. In certain embodiments, system (200) can (e.g. using monitoring module (250)) determine, repeatedly, if a liquidation trigger in respect of a mirror portfolio is met (including a changed liquidation trigger), as will further be detailed with reference to FIGS. 9 and 11. Upon the system determining that a liquidation trigger is met, the system can further be configured (e.g. using trading module (220)) to liquidate the mirror portfolio (700), e.g. as detailed below with reference to FIG. 8A (detailing a stop loss trigger) and FIG. 8B (detailing a take profit trigger). Upon determining that no liquidation triggers are met, the system can further be configured (e.g. using monitoring module (250)) to determine if a trading position corresponding to a mirror trading position in the basket of trading positions was closed (e.g. by the copied trader), in which case the system can automatically close the corresponding mirror trading position (710). It is to be noted that monitoring module (250) can also be configured to identify one or more new target trading positions to mirror for the copying trader in the mirror portfolio, and add one or more new mirror trading positions to the basket of trading positions.

Referring now to FIGS. 8A-8B, there is provided further details of liquidation in the case of a stop loss trigger and a take profit trigger. FIG. 8A illustrates a generalized flow chart of monitoring a mirror portfolio value in the case of a stop loss liquidation trigger, and liquidating the mirror portfolio or changing the liquidation trigger, in accordance with certain embodiments. System (200) can be configured (e.g. using monitoring module (250)) to monitor (800) the mirror portfolio value, as will further be detailed below with reference to FIG. 9. Upon determining a decrease in portfolio value, system (200) determines whether the stop loss liquidation trigger is breached. If the stop loss liquidation trigger is breached, the system automatically liquidates (810) the mirror portfolio, otherwise the system continues monitoring the portfolio value. Upon determining an increase in portfolio value, the system determines, in the case that the stop loss trigger is a trailing stop loss trigger, if the criteria for raising the liquidation trigger is met, in which case the system automatically raises (820) the stop loss liquidation trigger. Otherwise, if the stop loss trigger is not a trailing stop loss trigger or the trigger change criteria have not been met, the system continues monitoring the portfolio value.

FIG. 8B illustrates a generalized flow chart of monitoring a mirror portfolio value in the case of a take profit liquidation trigger and liquidating the mirror portfolio or changing the liquidation trigger, in accordance with certain embodiments. System (200) can be configured (e.g. using monitoring module (250)) to monitor (825) the mirror portfolio value, as will further be detailed below with reference to FIGS. 9 and 11. Upon determining an increase in portfolio value, system (200) further determines whether the take profit liquidation trigger is breached. If the take profit liquidation trigger is breached, the system automatically liquidates (830) the mirror portfolio, otherwise the system continues monitoring the portfolio value. Upon determining a decrease in portfolio value, the system determines, if the take profit trigger is a trailing take profit trigger, if the criteria for lowering the liquidation trigger is met, in which case the system automatically lowers (840) the take profit liquidation trigger. Otherwise, the system continues monitoring the portfolio value. It is to be noted that in the example provided in FIG. 8B, is demonstrative of a trailing take profit trigger that is lowered upon the portfolio value declining. However, as noted above with respect to FIG. 5C, in some cases the trailing take profit is raised when the portfolio value increases and is not lowered when the portfolio value declines. In such a case, the liquidation trigger can be raised upon the system determining an increase in portfolio value, and kept unchanged upon the system determining a decrease in portfolio value. This variant is illustrated in FIG. 8C, in which if the system determines that the mirror portfolio value has decreased, no action is taken (850). If the system determines that the value increased, if the take profit trigger is breached, the portfolio is liquidated (860) if the take profit trigger is not breached, the system checks whether the take profit is a trailing take profit trigger, and if so, whether the criteria for raising the trigger are met, in which case the trigger is raised (870).

In certain embodiments, system (200) can (e.g. using monitoring module (250) determine if a liquidation trigger is breached in respect of a portfolio of trading positions while reducing the computationally complexity ordinarily required for the task, as will be detailed with reference to FIG. 9, illustrating a generalized flow chart of determining if a liquidation trigger is breached, in accordance with certain embodiments. Referring now to FIG. 9, in certain embodiments, system (200) can (e.g. using monitoring module (250)) obtain (900) (e.g. from a memory) a liquidation trigger (including, e.g. a changed liquidation trigger) in respect of a mirror portfolio comprising a basket of trading positions. System (200) can (e.g. using monitoring module (250)) set (902) a target price threshold for each instrument held (i.e. traded) in a trading position in the basket of trading positions (examples for setting target price thresholds are detailed below). System (200) can (e.g. using monitoring module (250)) compare (904), for each instrument in the basket, the given instrument's price with its respective target price threshold, thereby performing a computationally inexpensive operation as will further be detailed below. In certain embodiments, the comparing (904) is performed for a given instrument each time the current price of the given instrument is updated (which can be multiple times per second), thus the computationally inexpensive operation is performed repetitively.

Upon determining that a target price threshold in respect of any instrument is breached, system (200) can (e.g. using monitoring module (250)) calculate (906) the mirror portfolio value using a series of computationally expensive operations, as will be detailed below, and thereafter determine if the mirror portfolio value breaches the liquidation trigger.

If, upon comparing (904) each instrument's current price with its respective target price threshold, the system determines that no target price threshold is breached, system (200) can skip the computationally expensive operations required to calculating the mirror portfolio value (since the liquidation trigger will not be breached) and can revert to comparing (904) each time an instrument price is updated.

Upon determining that the mirror portfolio value breaches the liquidation trigger, system (200) can (e.g. using trading module (220)) liquidate (908) the mirror portfolio. However, if upon calculating (906) the portfolio value using the series of computationally expensive operations, system (200) determines that the liquidation trigger is not breached, system (200) can revise (908) one or more target price thresholds such that no target price thresholds are breached in respect of the current prices of the respective instruments (examples for setting target price thresholds are detailed below), and revert to comparing (904) each fame an instrument price is updated.

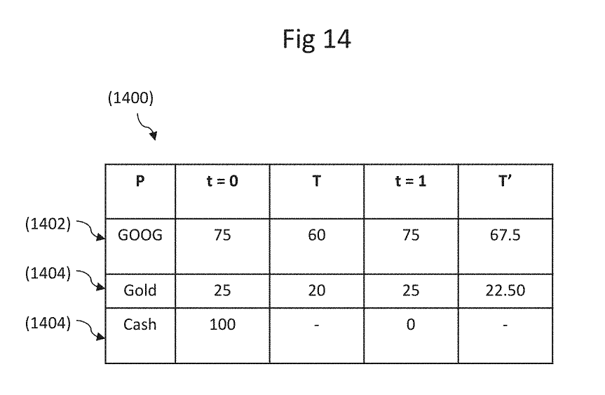

In certain embodiments, system (200) can also reuse one or more target price thresholds in response to other events, e.g. a change in the cash component of the portfolio, as will be further detailed below with reference to FIGS. 14 and 15, or a change in the liquidation trigger, or a new trading position opened or an existing trading position closed.

The following example (referred to hereafter as the “TPT Example”) illustrates how target price thresholds can be set according to certain embodiments of the disclosed subject matter. Assume the mirror portfolio has a current value of $1000, of which $500 is held in cash and $500 is invested in the following three open trading positions:
1. Sell 100,000 Units of EURUSD (open rate is 1.1000)
2. Buy 500 units of AAPL (open rate is 100.00)
3. Sell 1000 units of OIL (open rate is 50)

Further assume that the trader has specified a stop loss liquidation trigger of 50% of the mirror portfolio value, i.e. liquidate the mirror portfolio upon the portfolio value breaching $500.

To calculate the target price thresholds of EURUSD, AAPL, and OIL, first calculate the value in USD of ail open trading positions:

Value of all open trades in USD=100,000*1.1+500*100+1000*50=$210,000 USD

Next, assign each trading position a pro rata share of the total value, and multiply each position's pro rata share of the total by the liquidation value (i.e. the portfolio value which is required to liquidate the portfolio) to arrive at the position value which would require the portfolio to be liquidated (assuming no change in the other trading positions):

The EURUSD position is assigned 110,000/210000=0.5238. Multiple 0.5238*$500 (the Stop Loss %*Value of the Mirror account in USD)=$261.90

Next, calculate the rate change in EURUSD which is required for the trading position to lose $261.90. The result is a rate change to approximately 1.10262. That is, for the EURUSD position to lose $261.90, the EURUSD rate should reach to about 1.10262. Therefore, the target price threshold for EURUSD is set to 1.10262.

The AAPL position is assigned 50,000/210000=0.2380. Multiplying by $500 (the Stop Loss %*Value of the Mirror account in USD) yields $119. For the AAPL position to lose $119 requires a rate change in AAPL (from the current rate) to about $99.76. therefore, the target price threshold for AAPL is set to $99.76.

The OIL position is assigned 50,000/210000=0.2380. Multiplying by $500 (the Stop loss %*Value of the Mirror account in USD) yields $119. For the OIL position to lose $119 requires a rate change in OIL (from the current rate) to about $50.12. Therefore, the target price threshold for OIL is set to $50.12.

Another aspect of the presently disclosed subject matter relates to reducing the computational complexity required for a processor to perform repetitive processing of a plurality of objects in each of a plurality of repetitions, to determine if a certain condition is met in order to take an action, where the processing of the plurality of objects in a given repetition requires the processor to first process each object using a computationally expensive operation.

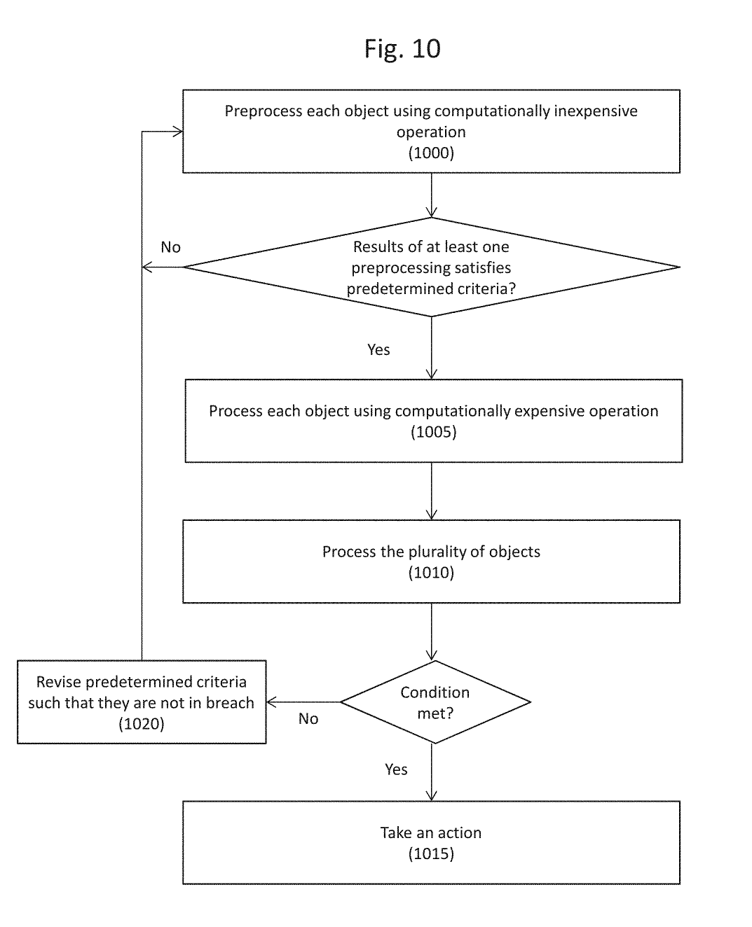

FIG. 10 illustrates a generalized flow chart of reducing the computational complexity required for a processor to perform a task related to repetitively processing a plurality of objects in each repetition out of a plurality of repetitions and determining, if a condition is met in respect of the plurality of objects in any given repetition, to take an action, in accordance with certain embodiments.

In certain embodiments, system (200) can (e.g. using monitoring module (250)), in each repetition of the plurality of repetitions, prior to processing each object using the computationally expensive operation, preprocess (1000) each object using a computationally inexpensive operation, and can determine if the results of at least one preprocessing in respect of at least one object satisfies a predetermined criteria. In certain embodiments, each object in the plurality of objects can be obtained from a computerized memory (e.g. data repository (203)) prior to processing the object. In certain embodiments, processing an object using a computationally expensive operation can include, e.g., processing a trading position in respect of a financial instrument in order to calculate a position P&L associated with the trading position, as will further be detailed below with reference to FIG. 11, illustrating a generalized flow chart of reducing the computationally complexity required for a processor to determine if a mirror portfolio value breaches a liquidation trigger.

In certain embodiments, preprocessing an object using a computationally inexpensive operation can include, e.g., comparing, for a given trading position in respect of a given financial instrument, a current market price of the instrument to a target price threshold, as will further be detailed below with reference to FIG. 11, illustrating a generalized flow chart of reducing the computationally complexity required for a processor to calculate a mirror portfolio value.

In certain embodiments, only upon determining that the results of at least one preprocessing in respect of at least one object satisfies a predetermined criteria, system (200) can (e.g. using monitoring module (250)) thereafter process (1005), in the given repetition, each object using the computationally expensive operation. Otherwise, system (200) can continue to next repetition of preprocessing (1000) each object using the computationally inexpensive operation, thereby reducing the number of computationally expensive operations performed in one or more repetitions.

Upon having processed (1005) each object in the plurality of objects using the computationally expensive operation, system (200) can thereafter process (1010) the plurality of objects in order to determine if the condition for taking an action is met. Upon determining that the condition is met, system (200) can take the action (1015), and otherwise system (200) can avoid taking the action. In certain embodiments, processing the plurality of objects in order to determine if the condition is met can include, e.g. processing a plurality of trading positions in a portfolio to calculate a portfolio value (e.g. by summing the P&L of each trading position and adding the invested amount and cash, as detailed above) and thereafter determining if the portfolio value breaches a liquidation trigger, in which case the system can liquidate the portfolio.

In certain embodiments, if the condition for taking an action is not met, system (200) can (e.g. using monitoring module (250)) revise (1020) one or more of the predetermined criteria, e.g. based on a current state of one or more objects, such that no predetermined criteria will be satisfied in the next repetition (see the TPT Example detailed above for setting target price thresholds). In certain embodiments, revising one or more predetermined criteria can include, e.g. setting one or more target price thresholds in respect of one or more instruments, as further detailed below with reference to FIG. 11, illustrating a generalized flow chart of reducing the computationally complexity required for a processor to determine if a mirror portfolio value breaches a liquidation trigger.

As detailed above, by first comparing one or more current market prices of traded financial instruments in a portfolio with respective target price thresholds prior to calculating a portfolio value, one or more computationally expensive operations can thereby be saved, resulting in reduced computationally complexity.

For example, in certain embodiments, determining the P&L of any given trading position can be a computationally expensive operation requiring the processor to, e.g., determine an initial price of the financial instrument (e.g. the price at which the trading position was opened), determine a current price of the financial instrument, determine the number of units traded in the trading position, and multiply the difference between the current price and the initial price by the number of units to derive the P&L of the trading position. In addition, in certain types of trading positions, an additional step of converting the trade currency to the portfolio currency is applied. For example, for a trading position in EUR/JPY, the P&L of the position is first calculated as detailed above, and then a conversion rate is applied to convert the resulting P&L (in Japanese currency) to, e.g. U.S. dollars. For other types of trailing positions, the P&L calculation can be even more complicated. For example, an outright “forward” position also requires the processor to obtain a current interest rate (updated 24/7) to calculate the P&L. Option positions also require obtaining interest rate updates and, additionally, standard deviation (i.e. volatility) in order to calculate the P&L of the position.

Based on the above, a simple trading position can require five (5) logical steps, as detailed above, which can require, in some cases, approximately 80-120 assembler instructions, or approximately 100 assembler instructions. In certain embodiments, a semi-sophisticated position can require eight (8) logical steps, or, in some cases, approximately 110-150 assembler instructions, or, in some cases, approximately 130 assembler instructions. In certain embodiments, a sophisticated position can require fifteen (15) logical steps, or, in some cases, approximately 230-270 assembler instructions, or, in some cases, approximately 250 assembler instructions. In certain embodiments, these instructions have to be executed for each price update of each instrument in each position of each trading portfolio in a trading system, such as the presently disclosed mirror trading system.

In certain embodiments, comparing a given instrument's current market price to a target price threshold can be a computationally inexpensive operation, requiring e.g., as little as three to five (3-5) assembler instructions.

There follows now a non-limiting example detailing how the disclosed method can be put into practice, e.g. in a trading system such as the mirror trading system disclosed in the present application, in order to reduce the computationally complexity required for a processor to determine if a liquidation trigger in respect of a portfolio comprising a basket of trading positions is breached.

FIG. 11 illustrates a generalized flow chart of reducing the computationally complexity required for a processor to determine if a mirror portfolio value breaches a liquidation trigger, the mirror portfolio comprising a basket of trading positions, and to liquidate the portfolio if the value breaches a liquidation trigger, in accordance with certain embodiments. System (200) can (e.g. using monitoring module (250)) set (1100) a target price threshold for each of a plurality of instruments held in a respective plurality of trading positions comprised in the basket of trading positions (see the TPT Example detailed above for setting target price thresholds). System (200) can (e.g. using monitoring module (250)) compare (1102) each instrument's current market price with its respective target price threshold (a computationally inexpensive operation, as detailed above) and determine if the target price threshold in respect of any instrument is breached. Upon determining at least one breach, system (200) can (e.g. using monitoring module (250)) then calculate (1103) the P&L of each position in the basket (a computationally expensive operation), as detailed above, and thereafter can calculate (1104) the portfolio value, as detailed above. Otherwise, if no target price thresholds are breached, system (200) can avoid calculating the portfolio value (since the liquidation trigger will not be met), thereby reducing the computational complexity by not having to calculate each position's P&L each time the current price of the instrument held in the given position is updated.

Upon calculating the portfolio value, system (200) can (e.g. using monitoring module (250)) compare (1105) the portfolio value to one or more liquidation triggers and determine if a liquidation trigger is met. If a liquidation trigger is met, system (200) can (e.g. using trading module (220)) liquidate (1105) the portfolio. Otherwise, system (200) can set (1101) one or more target price thresholds (i.e. revised target price thresholds (see the TPT Example detailed above for setting target price thresholds)) and continue the comparing (1102), thereby reducing the need to calculate a portfolio value (a computationally expensive operation) in one or more repetitions (i.e. of receiving current price updates).

Having described the general process, there is now provided further details of setting target price thresholds. In certain embodiments, the system can set target price thresholds in respect of the given instruments based on various factors. By way of non-limiting example, one factor can be, e.g. the volatility of the instrument during a given time period (since it may desirous to set a target pace threshold that is not likely to breached in the relatively near future, i.e. a few seconds, minutes or days as the case may be, in response to the “normal” price fluctuations of the given instrument). Another factor can be, e.g. the size of the position (number of units multiplied by unit price) relative to the size of the portfolio (sec the TPT Example detailed above for setting target price thresholds), since the larger the given position in the portfolio, the more sensitive the portfolio value is to price fluctuation in the instrument associated with the given position.

In certain embodiments, target price thresholds can be set for each instrument held in a trading position in the basket of trading positions in a portfolio such that if all target price thresholds are breached simultaneously, the portfolio value will breach a liquidation trigger. For example, given a portfolio consisting of positions in instruments i, i=1 . . . n, target price thresholds Tᵢ_{ₛ}, can be set for instruments i such that the following equation holds true:

$${\sum }_{i = 1}^{n} ( ( {T}_{i} - Open Rates ( i ) ) * {U}_{i} * conversion rate * direction sign ) + Cash <= {V}_{L}$$

where OpenRates(t) is the price of i at which the trading position in i was opened, Uᵢ is the number of units of i held in a trading position, conversion rate is the value for converting the currency of the trading position to a common coin (e.g. USD), direction sign=1 on long base asset deals and (−1) on short base asset deals, and V_{L} is the portfolio value that will breach the liquidation trigger.

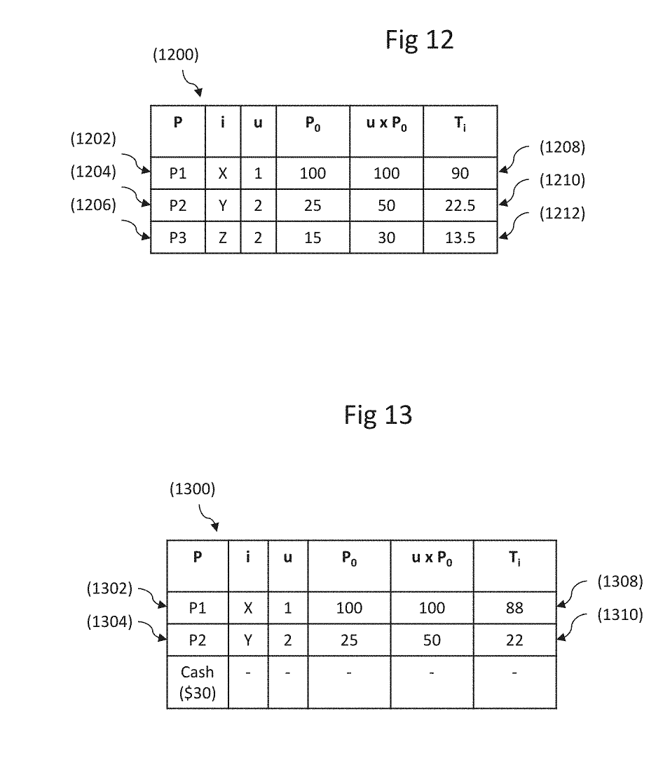

FIG. 12 illustrates a first non-limiting example of setting target price thresholds, in accordance with certain embodiments of the presently disclosed subject matter. Table (1200) shows the composition of a mirror portfolio having investments totalling $180 and no cash. The investments consist of trading positions P1, P2 and P3, as follows.

P1 (1202) consisting of one (1) unit (u) of instrument (i) “X” at an initial price (p₀) of $100 per unit,

P2 (1204) consisting of two (2) units of “Y” at an initial price of $25 per unit; and

P3 (1206) consisting of two (2) units of “Z” at an initial price of $15 per unit, for an initial portfolio value Vₚ of $180 (i.e. (1×$100)+(2×$25)+(2×$15)). A stop loss trigger is set for −10%, translating to a portfolio value V_{L} of $162 (i.e. $180−(180×0.10)). Therefore, initial target price thresholds can be set for X, Y and Z, such that if all thresholds are simultaneously breached, V_{P}=V_{L}=$162. Note that this example applies to non-leveraged deals and is provided as another example to the TPT Example which also covers leveraged deals.

Table (1200) shows possible target price thresholds (T) of X (T_{X}) (1208) set to $90, of Y (T_{Y}) (1210) set to $22.50, and of Z, (T_{Z}) (1212) set to $13.5, since (1×90)+(2×22.50)+(2×13.50)=162, thereby satisfying the constraint that when all target price thresholds are breached V_{P}=V_{L}=$162.

It will be appreciated that in the example provided there are a range of possible values for T_{X}, T_{Y} and T_{Z} that will satisfy the constraint V_{P}=V_{L}. Therefore, further constraints may be applied to set a given threshold. For example, in certain embodiments, a given instrument's price target price threshold T can be set as follows. First, calculate the difference D between the value of the invested portion of the portfolio (V_{P}) and expected value at liquidation V_{L} (i.e. D=|V_{P}−V_{L}|). Then apportion this difference D between the trading positions in the portfolio pro rata, e.g. based on position size (i.e. units×price/unit) For example, referring to FIG. 12, note that D=18 (i.e. $180−$162). Note also that since the liquidation trigger is lower than the current portfolio value (i.e. V_{P}>V_{L}), each target price threshold is lower than the current instrument price by a pro rata portion based on the position size, as follows:

1. One unit of X accounts for $100 out of $180 of the portfolio (P1+P2+P3=180), therefore T_{X} can be set to the current price ($100) less $10 (i.e. 18×(100÷180)÷1), for a T_{X} of $90 ($100−$10);

2. Two units of Y accounts for $50 out of $180 (P1+P2+P3=180); therefore T_{Y} can be set to the current price ($25) less $2.50 (i.e. 18×(50÷180)÷2) for a T_{Y} of $22.50 ($25−$2.50); and

3. Z's position accounts for $30 out of $180 (P1÷P2+P3=180); therefore T_{Z} can be set to the current price ($15) less $1.50 (i.e. 18×(30÷180)÷2) for a T_{Z} of $13.50 ($15−$1.50).

FIG. 13 illustrates a second non-limiting example of setting target price thresholds, in accordance with certain embodiments of the presently disclosed subject matter. Table (1300) shows a mirror portfolio having investments totalling $150 and $30 cash, including trading positions:

P1 (1302) consisting of one (1) unit (u) of instrument (I) X at an initial price (p₀) of $100 per unit; and

P2 (1303) consisting of two (2) units of Y at an initial price of $25 per unit

Therefore P1+P2+Cash=V_{P}=$150. Once again, a stop loss trigger is set for −10%, translating to a portfolio value V_{L} of $162 (i.e. $180−(180×0.10)). However because the cash portion ($30) is fixed, to satisfy V_{P}=V_{L} we need to define a new variable V_{IP} as the value of the invested portion of the portfolio (P1+P2) and find target price threshold T that satisfy V_{IP}+30=V_{L}. Therefore, initial target price thresholds can be set for X and Y such that if all thresholds are simultaneously breached, the combined value of the investments V_{IP} will equal $132 (i.e. $162−$30). It is to be noted that this example applies to non-leveraged deals. For leveraged deals, the TPT Example detailed previously can be used instead. Table (1300) shows possible target price thresholds (T) as T_{X} (1308) set to $88, and T_{Y} (1310) set to $22, since (1×88)+(2×22)=132, thereby satisfying the above constraint and guaranteeing that when both T_{X} and T_{Y} are breached, V_{P}=V_{L}=$162.

In addition, each of T_{X} and T_{Y} are set lower than the current price X and Y, respectively, by a pro rata amount based on position size, e.g. as follows:

1. One unit of X accounts for $100 out of $150 (P1+P2=150); therefore X's price target threshold is set at $12 (18×(100÷150)÷1) lower than the current price of X for a target price threshold of $88 ($100−$12);

2. Two units of Y account for $50 out of $150 (P1+P2=150); therefore Y's price target threshold is set at $3 (18×(50÷150)÷2) lower than the current price of Y for a target price threshold of $22 ($25−$22);

In certain embodiments, the difference D can be divided amongst the instruments in other way, e.g. according to each instrument's volatility during a specific time period.

In certain embodiments, revising one or more target price thresholds can be performed in the same manner as setting initial price target thresholds by setting V_{P} to the current portfolio value (and setting V_{IP}=V_{P}−Cash, where applicable), or in any other manner. In certain embodiments, revised target price thresholds may be set such that no price target threshold is breached based on the current price of the given instrument.

It should be noted that in certain embodiments, if the composition of the portfolio changes (including, e.g. opening and/or closing trading positions (for example as a result of mirror trading), or adding or withdrawing cash as will be detailed below, etc.) or the liquidation trigger is changed, the target price thresholds may need to be reset in accordance with the current state of the portfolio and/or current liquidation trigger. Therefore it is to be noted that in certain embodiments, monitoring module (250) can further be configured to monitor the portfolio and, upon detecting certain predefined events occurring in the portfolio (including, e.g. a trading position in the portfolio being closed, a new trading position being opened in the portfolio, cash being withdrawn, cash being added, a liquidation trigger being changed, etc.) automatically revise one or more target price thresholds in accordance with the current state of the portfolio.

In certain embodiments, if cash is transferred in or out of the portfolio (including, e.g., in response to a copied trader transferring cash in or out as detailed above), the system can revise the target price thresholds accordingly.

By way of non-limiting example, FIG. 14 illustrates a table (1400) showing a portfolio at time t=0 and then again at time t=1. At time=0, the illustrated portfolio comprises a $75 position in Google shares (GOOG) (1402) (one unit), a $25 position in Gold (1404) (one unit) and $100 cash (1406) for a portfolio value of $200 ($75+$25+$100). The trader input a liquidation trigger of −10%, which the system can translate to a portfolio value of $180. Therefore the combined investment in GOOG and Gold has to lose $20 for the portfolio value to meet the liquidation trigger of $180. The $20 can be apportioned between GOOG and Gold as detailed above with reference to FIGS. 12 and 13, such that T_{GOOG} is set at $60 while T_{GOLD} is set at $20.

It is to be noted that this example applies to non-leveraged deals. For leveraged deals, the TPT Example detailed previously can be used instead. At time t=1, the $100 cash is transferred out, resulting in a portfolio value now of $100 of which $75 is in GOOG and $25 is in Gold. Therefore, the −10% liquidation trigger is translated to a portfolio value of $90, As such, the combined investment in GOOG and Gold now has to lose only $10 to meet the liquidation trigger. This $10 is apportioned between GOOG and Gold as detailed above with reference to FIG. 12 (no cash) and FIG. 13 (cash), such that T_{GOOG} is revised to $67.50 while T_{GOLD} is revised to $22.50. It should be noted that had the trader input a fixed value liquidation trigger, there would be no need to revise the target price thresholds. In some cases, the system can also prevent the trader from withdrawing an amount of money that will create a breach of the liquidation trigger.

Referring now to FIG. 15, there is illustrated a generalized flow chart of transferring cash between a given trader's regular portfolio and the given trader's mirror portfolio, in accordance with certain embodiments. System (200) can (e.g. using monitoring module (250)) monitor (1501) a trading portfolio of a copied trader to determine if the copied trader transfers cash in or out of the copied trader's portfolio.

Upon determining that cash was transferred out of the copied trader's portfolio, system (200) can calculate (1502) a corresponding amount of cash that the copying trader should transfer out of the copying trader's mirror portfolio to order to keep “mirroring” the copied trader using the same proportion of invested funds. Conversely, upon determining that cash was transferred into the copied trader's portfolio, system (200) can calculate (1503) a corresponding amount of cash that the copying trader should transfer into the copying trader's mirror portfolio.

In certain embodiments, system (200) can also transfer (1504) the calculated cash amount between the copying trader's regular portfolio and the copying trader's mirror portfolio. In certain embodiments, system (200) can first request permission from the copying trader before transferring the calculated amount.

Upon making the transfer, system (200) can revise (1505) one or more target price thresholds in respect of one or more instruments held in a trading position in the copying trader's mirror portfolio.

It is to be noted that the invention is not bound to the specific method of setting and/or revising price target thresholds, as provided above by way of non-limiting example.

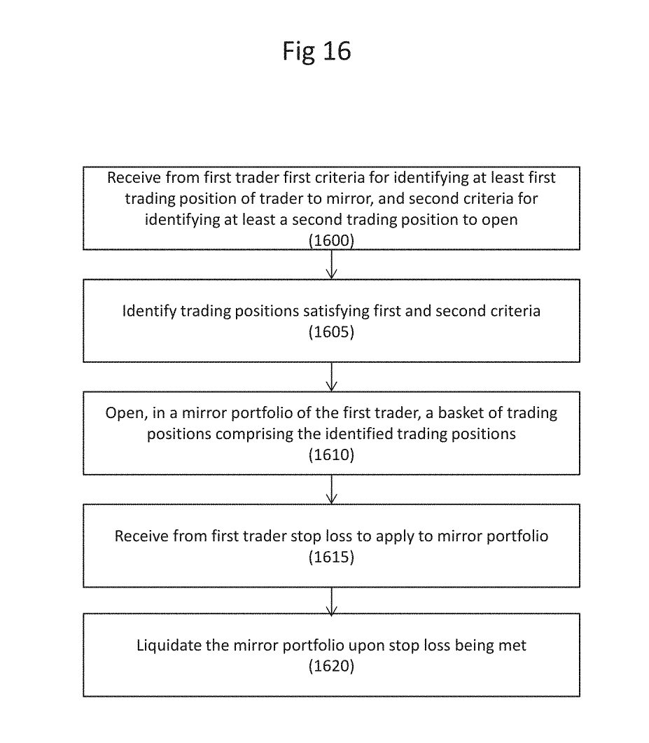

Reference is now made to FIG. 16, where there is provided an additional example of a sequence of operations that may be performed by a mirror trading system in order to facilitating mirror trading of financial instruments in a trading network.

FIG. 16 illustrates a generalized flow chart of facilitating mirror trading of financial instruments in a trading network by automatically liquidating a mirror portfolio in response to a liquidation trigger being met, in accordance with certain other embodiments. System (200) can receive (1600), from a copying trader, first criteria for identifying at least one trading position opened by a first copied trader, in respect of at least one financial instrument, to mirror for the copying trader in a mirror portfolio associated with the copying trader, and second criteria for identifying at least one second trading position. The second trading position can be a target trading position opened by a second copied trader (different from the first copied trader) to mirror for the copying trader, or the second trading position can be a regular (i.e. non-mirror) trading position. The first and second criteria can be received at client interface (204) and transferred to data repository (203). System (200) can then obtain the first and second criteria from data repository (203).

In certain embodiments, the first criteria can include, e.g. information sufficient to discern the first copied trader from other traders in the trading network, as detailed above with reference to FIG. 3, illustrating a generalized flow chart of a sequence of operations carried out for facilitating mirror trading of financial instruments in a trading network. The description (and examples) of criteria sufficient to discern a copied trader, as provided above with reference to FIG. 3 applies, mutatis mutandis, to FIG. 16.

In the case that the second trading position is a target trading position opened by a second copied trader (different from the first copied trader), the second criteria can include, e.g., information sufficient to discern the second copied trader from other traders in the trading network, as detailed above with reference to FIG. 3, illustrating a generalized flow chart of a sequence of operations carried out for facilitating mirror trading of financial instruments in a trading network. The description (and examples) of criteria sufficient to discern a copied trader, as provided above with reference to FIG. 3 applies, mutatis mutandis, to FIG. 16.

In the case that the second trading position is a regular trading position, the second criteria can include, e.g., information sufficient to discern a given trading position to open for the copying trader, for example as detailed above with reference to FIG. 3, illustrating a generalized flow chart of a sequence of operations carried out for facilitating mirror trading of financial instruments in a trading network. The description (and examples) of criteria sufficient to discern a given trading position to open for the copying trader provided above with reference to FIG. 3 applies, mutatis mutandis, to FIG. 16.

In certain embodiments, system (200) can (e.g. using matching module (240)) identify (1605) at least one trading position opened by the first copied trader that satisfies the first criteria, and at least one trading position satisfying the second criteria, as detailed above with reference to FIG. 3, illustrating a generalized flow chart of a sequence of operations carried out for facilitating mirror trading of financial instruments in a trading network. The description (and examples) provided above with reference to FIG. 3 applies, mutatis mutandis, to FIG. 16.

In certain embodiments, system (200) can (e.g. using trading module (220)) open (1610), in a mirror trading portfolio associated with the copying trader, a basket of trading positions comprising the identified trading positions, as detailed above with reference to FIG. 3, illustrating a generalized flow chart of a sequence of operations carried out for facilitating mirror trading of financial instruments in a trading network. The description (and examples) provided above with reference to FIG. 3 applies, mutatis mutandis, to FIG. 16.

In certain embodiments, system (200) can receive (1615) from the copying trader (e.g. via client interface (204)) a stop loss trigger to apply to the mirror portfolio which, if met, results in system (200) automatically liquidating the mirror portfolio, by liquidating (i.e. closing out) all trading positions in the basket of trading positions, as further detailed above with reference to FIG. 3, illustrating a generalized flow chart of a sequence of operations carried out for facilitating mirror trading of financial instruments in a trading network. The description (and examples) provided above with reference to FIG. 3 applies, mutatis mutandis, to FIG. 16.

In certain embodiments, system (200) can further be configured (e.g. using trading module (220)) to automatically liquidate (1620) the mirror portfolio upon the stop loss trigger being met, by liquidating the basket of trading positions, as detailed above with reference to FIG. 3, illustrating a generalized flow chart of a sequence of operations carried out for facilitating mirror trading of financial instruments in a trading network. The description (and examples) provided above with reference to FIG. 3 applies, mutatis mutandis, to FIG. 16.

In certain embodiments, liquidating (1620) includes, e.g. using a method for reducing the computational complexity required for determining if the stop loss trigger is met, as detailed above with reference to FIGS. 9 and 11, and which likewise apply, mutatis mutandis, to FIG. 16.

In certain embodiments, upon the stop loss trigger not being met system (200) can (e.g. using monitoring module (250)) monitor one or more trading positions corresponding to a respective one or more mirror trading positions in the basket, and can automatically close a mirror trading position (e.g. without liquidating the basket) in response to detecting the corresponding trading position being closed, as further detailed above with reference to FIGS. 3 and 7 and which likewise apply here, mutatis mutandis.

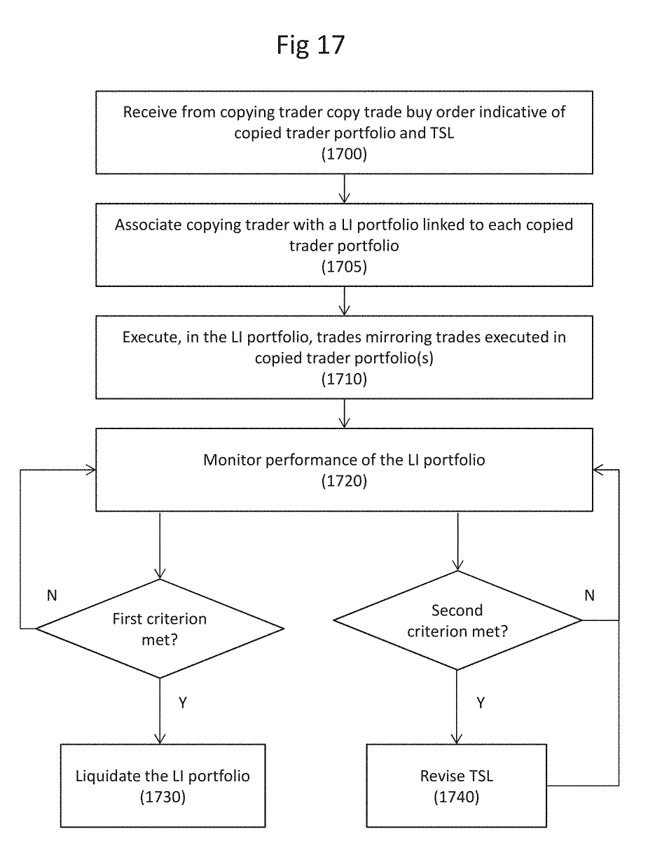

Referring now to FIG. 17, there is illustrated another example (non-limiting) of a sequence of operations for facilitating copy trading of financial instruments, in accordance with certain embodiments of the presently disclosed subject matter.

In certain embodiments, system (200) can receive (e.g. via client interface (204)) from a copying trader a copy trading buy order. The copy trading buy order can include an indication of, e.g. at least one copied trader's portfolio associated with a copied trader that the copying trader is desirous of copying, and a trailing stop loss value. In certain embodiments, the copy trading buy order can further include, e.g. an indication of a portfolio associated with the copying trader to link to the copied trader's portfolio.

In certain embodiments, system (200) can (e.g. in data repository (203)) associate (1705) the first trader with a linked investment (LI) portfolio linked to each copied traders portfolio. In certain embodiments, system (200) can (e.g. using trading module (220)) execute (1710) in the LI portfolio, one or more trades in respect of one or more instruments in accordance with the copy trading buy order the one or more trades mirroring one or more trades executed in one or more copied trader portfolio.

In certain embodiments, system (200) can (e.g. using monitoring module (250), monitor (1720) the performance of the LI portfolio, and can (e.g. using trading module (220)) liquidate (1730) the LI portfolio upon the performance meeting a first criteria, and revise (1740) the TSL value upon the performance meeting a second criteria. In certain embodiments, the first criteria can be met upon the monitored performance being indicative of the LI portfolio value meeting the trailing stop loss. In certain embodiments, the second criteria can be met upon the monitored performance being indicative of the LI portfolio value increasing/decreasing to at least a predetermined threshold amount.

It is noted that the description and examples which were discussed above and with reference to FIGS. 3-16 likewise apply to the description of FIG. 17 mutatis mutandis.

It is noted that the teachings of the presently disclosed subject matter are not bound by the mirror trading system described with reference to FIGS. 1-2. Equivalent and/or modified functionality can be consolidated or divided in another manner and can be implemented in any appropriate combination of software, firmware and hardware and executed on a suitable device. The network in which the mirror trading system operates can be a standalone network, or integrated, fully or partly, with other networks. Each component of the mirror trading system can be a standalone component, or integrated, fully or partly, with other components. Those skilled in the art will also readily appreciate that, one or more of the data repositories can be consolidated or divided in other manner, databases can be shared with other systems or be provided by other systems, including third party equipment.

It is further noted that the teachings of the presently disclosed subject matter are not bound by the flow charts illustrated in FIGS. 3, 6-11 and 15-17; the illustrated operations can occur out of the illustrated order. It is also noted that whilst the flow charts are described with reference to elements of system (200), this is by no means binding, and the operations can be performed by elements other than those described herein.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, a suitably programmed computer. Likewise, the invention contemplates a computer program being readable by a computer for executing the method of the invention. The invention further contemplates a machine-readable memory tangibly embodying a program of instructions executable by the machine for executing the method of the invention.

Those skilled in the art will readily appreciate that various modifications and changes can be applied to the embodiments of the invention as hereinbefore described without departing from its scope, defined in and by the appended claims.

1-196. (canceled)

197. A method of reducing computational complexity required for a processor operatively coupled to a memory to perform a task related to repetitively processing a plurality of objects in each repetition out of a plurality of repetitions and determining, if a condition is met in respect of the plurality of objects in any given repetition, to take an action, wherein processing the plurality of objects in a given repetition requires the processor to first process each object in the plurality of objects, in the given repetition, using a computationally expensive operation, the method comprising, by the processor:
in each repetition, obtaining each object from the memory and, prior to said first processing, preprocessing each object in the plurality of objects using a computationally inexpensive operation and determining if the results of at least one preprocessing in respect of at least one object satisfies a predetermined criteria, and
only upon determining that the results of at least one preprocessing of at least one object satisfies a predetermined criteria, thereafter processing each object using the computationally expensive operation and subsequently processing the plurality of objects to determine if the condition is met, and upon determining that the condition is met taking the action,
thereby reducing the number of computationally expensive operations required to be performed in one or more repetitions.

198. The method of claim 197, further comprising, upon determining that the condition is not met, revising at least one predetermined criteria in respect of at least one object in accordance with a current state of the at least one object, such that a next preprocessing of any given object in the plurality of objects will not result in a predetermined criteria in respect of the given object being satisfied.

199. The method of claim 197, wherein the plurality of objects is a plurality of trading positions in a respective plurality of financial instruments in a trading portfolio, the plurality of trading positions comprising a basket of trading positions, and
wherein the task is to calculate the value of the trading portfolio to determine if a liquidation trigger in respect of the trading portfolio is met, and the action is liquidating the trading portfolio, and
wherein repetitively processing the plurality of trading positions comprises repetitively calculating the value of the trading portfolio each time a current price of at least one of the financial instruments is updated.

200. The method of claim 197, wherein said first processing of a given trading position in respect of a given instrument using a computationally expensive operation comprises determining a P&L of the given trading position.

201. The method of claim 197, wherein the computationally inexpensive operation comprises, for a given position in respect of a given instrument, determining a current market price of the instrument, and comparing the market price with a predetermined target price threshold in respect of the given instrument.

202. The method of claim 201, wherein upon comparing the market price with the predetermined target price threshold in respect of the given instrument, the predetermined criteria is met upon the current market price breaching the predetermined target price threshold.

203. The method of claim 201, wherein the predetermined target price threshold for each instrument is determined prior to a given repetition in accordance with at least one of: a volatility of the instrument in a predetermined time period, a size of a position held in respect of the instrument, and a combination thereof.

204. The method of claim 201, wherein the predetermined target price threshold for one or more instruments is revised upon at least one of a trading position in the basket of trading positions being closed, an amount of cash being transferred in or out of the trading portfolio, a new trading position being opened, and a liquidation trigger being changed.

205. The method of claim 201, wherein the predetermined target price threshold for the one or more instruments is revised such that none of the target price thresholds will be breached in the next repetition.

206. The method of claim 199, wherein the liquidation trigger is one of the following: a stop loss, a take profit, a trailing stop loss, a trailing take profit.

207. A system for reducing computational complexity required for a processor to perform a task related to repetitively processing a plurality of objects in each repetition out of a plurality of repetitions and determining, if a condition is met in respect of the plurality of objects in any given repetition, to take an action, wherein processing the plurality of objects in a given repetition requires the processor to first process each object in the plurality of objects, in the given repetition, using a computationally expensive operation, the system comprising a processor operatively coupled to a memory and configured to:
in each repetition, prior to said first processing, obtain each object from the memory and preprocess each object in the plurality of objects using a computationally inexpensive operation and determine if the results of at least one preprocessing in respect of at least one object satisfies a predetermined criteria, and
only upon determining that the results of at least one preprocessing of at least one object satisfies a predetermined criteria, thereafter process each object using the computationally expensive operation and subsequently process the plurality of objects to determine if the condition is met, and upon determining that the condition is met taking the action,
thereby reducing the number of computationally expensive operations required to be performed in one or more repetitions.

208. The system of claim 207, wherein the processor is further configured to, upon determining that the condition is not met, revise at least one predetermined criteria in respect of at least one object in accordance with a current state of the at least one object, such that a next preprocessing of any given object in the plurality of objects will not result in a predetermined criteria in respect of the given object being satisfied.

209. The system of claim 207, wherein the plurality of objects is a plurality of trading positions in a respective plurality of financial instruments in a trading portfolio, the plurality of trading positions comprising a basket of trading positions, and
wherein the task is to calculate the value of the trading portfolio to determine if a liquidation trigger in respect of the trading portfolio is met, and the action is liquidating the trading portfolio, and
wherein repetitively processing the plurality of trading positions comprises repetitively calculating the value of the trading portfolio each time a current price of at least one of the financial instruments is updated.

210. The system of claim 207, wherein said first processing of a given trading position in respect of a given instrument using a computationally expensive operation comprises determining a P&L of the given trading position.

211. The system of claim 207, wherein the computationally inexpensive operation comprises, for a given position in respect of a given instrument, determining a current market price of the instrument, and comparing the market price with a predetermined target price threshold in respect of the given instrument.

212. The system of claim 211, wherein upon comparing the market price with the predetermined target price threshold in respect of the given instrument, the predetermined criteria is met upon the current market price breaching the predetermined target price threshold.

213. The system of claim 211, wherein the predetermined target price threshold for each instrument is determined prior to a given repetition in accordance with at least one of: a volatility of the instrument in a predetermined time period, a size of a position held in respect of the instrument, and a combination thereof.

214. The system of claim 211, wherein the predetermined target price threshold for the one or more instruments is revised such that none of the target price thresholds will be breached in the next repetition.

215. The system of claim 209 wherein the liquidation trigger includes one of the following: a stop loss, a take profit, a trailing stop loss, a trailing take profit.

216. A non-transitory storage medium comprising instructions embodied therein, that when executed by a processor comprised in a computer, cause the processor to perform a method of reducing computational complexity required for the processor to perform a task related to repetitively processing a plurality of objects in each repetition out of a plurality of repetitions and determining, if a condition is met in respect of the plurality of objects in any given repetition, to take an action, wherein processing the plurality of objects in a given repetition requires the processor to first process each object in the plurality of objects, in the given repetition, using a computationally expensive operation, the method comprising:
in each repetition, prior to said first processing, preprocessing each object in the plurality of objects using a computationally inexpensive operation and determining if the results of at least one preprocessing in respect of at least one object satisfies a predetermined criteria, and
only upon determining that the results of at least one preprocessing of at least one object satisfies a predetermined criteria, thereafter processing each object using the computationally expensive operation and subsequently processing the plurality of objects to determine if the condition is met, and upon determining that the condition is met taking the action,
thereby reducing the number of computationally expensive operations required to be performed in one or more repetitions.
